(19) United States
(12) Patent Application Publication
(10) Pub. No.: US 2020/0371734 A1
(43) Pub. Date: Nov. 26, 2020

(54) MULTIPLE DISPLAY REGION MANAGEMENT

(71) Applicant: LENOVO (Singapore) PTE. LTD., New Tech Park (SG)

(72) Inventors: Seiichi Kawano, Yokohama-shi (JP); Ryohta Nomura, Yokohama-shi (JP); Mitsuhiro Yamazaki, Yokohama-shi (JP)

(21) Appl. No.: 16/880,060

(22) Filed: May 21, 2020

(30) Foreign Application Priority Data
May 22, 2019 (JP) 2019-96044

(51) Int. Cl. G06F 3/14; G06F 3/041; G09G 5/38

(52) U.S. Cl. CPC G06F 3/1438; G09G 2354/00; G09G 5/38; G06F 3/0416

(57) ABSTRACT

Methods, apparatus, and computer program products for multiple display region management are disclosed herein. One method includes detecting a physical amount in accordance with a posture of a chassis. The method also includes determining a display mode to show a screen region for the channel in accordance with the posture. Apparatus, and computer program products that include and/or perform the methods are also disclosed herein.

### FIELD

The subject matter disclosed herein relates to computing systems and more particularly relates to devices and methods for managing displays having multiple display regions.

### BACKGROUND

In recent years, computing devices have been developed that are convertible between different postures or orientations. For example, laptops that are convertible into to tablets. Often, these devices need to re-orient that direction of the screen output depending on the orientation or configuration of the device. Further, a single computing device may be controlling multiple displays. However, some operating systems do not support switching between single and multiple displays when reorienting the computing device (see FIGS. 21A-22D). Another issue is that the computing device may be equipped with a touch sensor to accept a user's input via a virtual input apparatus (e.g., on-screen keyboard) that is implemented by the operating system, or other application program. The virtual input apparatus is a security risk as other applications may intercept the input.

### BRIEF SUMMARY

Various examples provide methods for managing multiple display regions in a computing system. Also disclosed are an apparatus and computer program product that perform the method. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a method for controlling display output of an apparatus with at least two display regions. The method also includes determining a screen region corresponding to a channel in the at least two display regions; and outputting request information for screen data corresponding to the screen region to a system device. Other embodiments of this aspect include corresponding computer systems, apparatus, and computer programs recorded on one or more computer storage devices, each configured to perform the actions of the methods.

Implementations may include one or more of the following features. The method may include detecting a physical amount in accordance with a posture of a chassis; and determining a display mode to show a screen region for the channel in accordance with the posture. The method may include detecting a direction of one display region of the at least two display regions relative to a user; and determining, in response to the direction, the display mode. The detection region is configured to detect a contact with an object; converting, in response to determining that the screen region extends across the at least two display regions, coordinates of a contact position where a contact is detected in the detection region that is superimposed on each of the at least two display regions to coordinates in the screen region; and outputting contact position data indicating the converted coordinates to a system device. The method may include: displaying, in response to selecting a display mode that includes a virtual input region that is at least part of the detection region, an image of a predetermined input unit in the virtual input region; and outputting, in response to detecting a contact in a region displaying a component of the predetermined input unit, an operating signal indicating an operation of a component to the system device. The method may include acquiring input information based on a trajectory of the contact position with converted coordinates; and outputting the input information to the system device. The method may include recognizing one or more characters that the trajectory indicates; and outputting text information indicating the characters to the system device. Implementations of the described techniques may include hardware, a method or process, or computer software on a computer-accessible medium.

One general aspect includes a computer-readable storage medium that stores a program executable by a processor. The computer-readable storage medium also includes determining a screen region corresponding to a channel in at least two display regions; and outputting request information for screen data corresponding to the screen region to a system device. Other embodiments of this aspect include corresponding computer systems, apparatus, and computer programs recorded on one or more computer storage devices, each configured to perform the actions of the methods.

Implementations may include one or more of the following features. The computer-readable storage medium where the steps further may include detecting a physical amount in accordance with a posture of a chassis; and determining a display mode to show a screen region for the channel in accordance with the posture. The steps further may include detecting a direction of one display region of the at least two display regions relative to a user; and determining, in response to the direction, the display mode. The steps further may include: superimposing, a detection region on each of the at least two display regions, where the detection region is configured to detect a contact with an object; converting, in response to determining that the screen region extends across the at least two display regions, coordinates of a contact position where a contact is detected in the detection region that is superimposed on each of the at least two display regions to coordinates in the screen region; and outputting contact position data indicating the converted coordinates to a system device.

The apparatus where the screen region corresponding to the channel includes a region extending across the at least two display regions. The request information may include information on a size of the screen region and an orientation to display the screen data. The input/output controller determines a display mode to show a screen region for the channel in accordance with the posture. The input/output controller detects a direction of one display region of the at least two display regions relative to a user, and refers to the direction to determine the display mode.

When the screen region extends across the at least two display regions, the input/output controller converts coordinates of a contact position where a contact is detected in the detection region superimposed on each of the at least two display regions to coordinates in the screen region, and outputs contact position data indicating the converted coordinates to the system device. When selecting a display mode including a virtual input region that is at least a part of the detection region, the input/output controller controls to display an image of a predetermined input unit in the virtual input region, and when a contact is detected in a region displaying a component of the predetermined input unit, the input/output controller outputs an operating signal indicating an operation of the component to the system device.

The input/output controller acquires input information based on a trajectory of the contact position with converted coordinates, and outputs the input information to the system device. The input/output controller recognizes one or more characters that the trajectory indicates, and outputs text information indicating the characters to the system device. Implementations of the described techniques may include hardware, a method or process, or computer software on a computer-accessible medium.

Implementations may include one or more of the following features. The apparatus where the screen region corresponding to the channel includes a region extending across the at least two display regions. The request information may include information on a size of the screen region and an orientation to display the screen data. The input/output controller determines a display mode to show a screen region for the channel in accordance with the posture. The input/output controller detects a direction of one display region of the at least two display regions relative to a user, and refers to the direction to determine the display mode.

When the screen region extends across the at least two display regions, the input/output controller converts coordinates of a contact position where a contact is detected in the detection region superimposed on each of the at least two display regions to coordinates in the screen region, and outputs contact position data indicating the converted coordinates to the system device. When selecting a display mode including a virtual input region that is at least a part of the detection region, the input/output controller controls to display an image of a predetermined input unit in the virtual input region, and when a contact is detected in a region displaying a component of the predetermined input unit, the input/output controller outputs an operating signal indicating an operation of the component to the system device.

The input/output controller acquires input information based on a trajectory of the contact position with converted coordinates, and outputs the input information to the system device. The input/output controller recognizes one or more characters that the trajectory indicates, and outputs text information indicating the characters to the system device. Implementations of the described techniques may include hardware, a method or process, or computer software on a computer-accessible medium.

### BRIEF DESCRIPTION OF THE DRAWINGS

A more particular description of the examples briefly described above will be rendered by reference to specific examples that are illustrated in the appended drawings. Understanding that these drawings depict only some examples and are not therefore to be considered to be limiting of scope, the examples will be described and explained with additional specificity and detail through the use of the accompanying drawings, in which:

FIG. 1 is a block diagram showing one example of an information processing apparatus, according to examples of the subject disclosure;

FIG. 2 is a perspective view diagram illustrating a display mode, according to examples of the subject disclosure;

FIGS. 3A1-3C2 are schematic block diagrams illustrating landscape views and portrait views, according to examples of the subject disclosure;

FIG. 4 is a schematic block diagram illustrating an example of a transition of the display modes, according to examples of the subject disclosure;

FIG. 5 is a schematic block diagram illustrating an input/output hub, according to examples of the subject disclosure;

FIG. 6 is a schematic block diagram illustrating a control table, according to examples of the subject disclosure;

FIGS. 7A-7H are schematic block diagrams illustrating examples of display modes, according to examples of the subject disclosure;

FIG. 8 is a schematic block diagram illustrating a first input/output example at the input/output hub, according to examples of the subject disclosure;

FIG. 9 is a diagram illustrating detection of a contact position, according to examples of the subject disclosure;

FIG. 10 is a schematic block diagram illustrating another example of the input/output hub, according to examples of the subject disclosure;

FIG. 11 is a schematic block diagram illustrating another example of the input/output hub, according to examples of the subject disclosure;

FIG. 12 is a schematic block diagram illustrating a hybrid display, according to examples of the subject disclosure;

FIG. 13 is a schematic block diagram illustrating a fourth input/output example at the input/output hub, according to examples of the subject disclosure;

FIGS. 14A-14C are schematic block diagrams illustrating examples of hybrid displays, according to examples of the subject disclosure;

FIGS. 15A-15C are diagrams illustrating examples of acquired trajectories of contact positions, according to examples of the subject disclosure;

FIGS. 16A and 16B are schematic block diagrams illustrating line feed displays, according to examples of the subject disclosure;

FIGS. 17A and 17B are schematic block diagrams illustrating other examples of line feed display, according to examples of the subject disclosure;

FIG. 18 is a schematic block diagram illustrating another example of a control table, according to examples of the subject disclosure;

FIGS. 19A and 19B are schematic block diagrams illustrating examples of a configuration of an information processing apparatus, according to examples of the subject disclosure;

FIGS. 20A and 20B are schematic block diagrams illustrating other examples of the configuration of an information processing apparatus, according to examples of the subject disclosure;

FIGS. 21A-21D are schematic block diagrams illustrating examples of a conventional display mode, according to examples of the prior art; and

FIGS. 22A-22D are schematic block diagrams illustrating examples of a conventional display mode, according to examples of the prior art.

### DETAILED DESCRIPTION

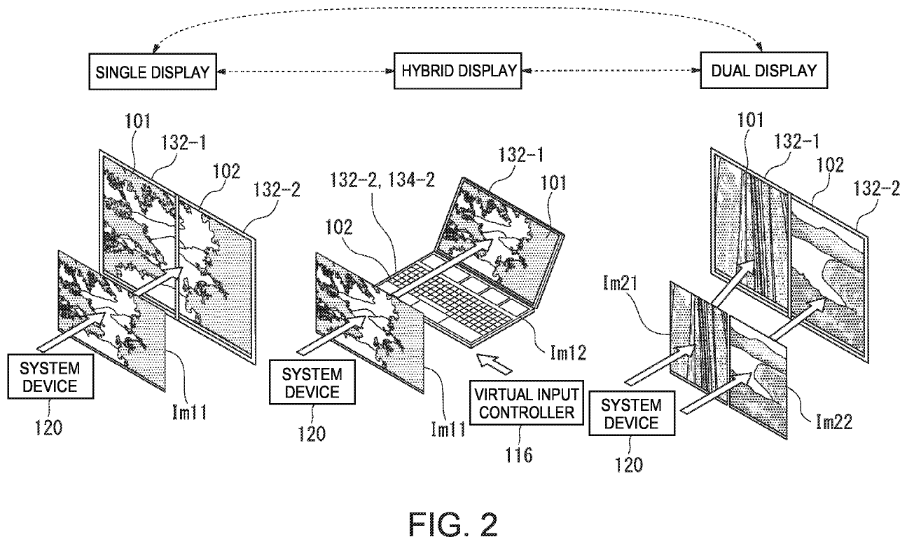

In the following, an information processing apparatus 10 with a . . . will be described. The following mainly describes the information processing apparatus 10 by way of an example of the laptop PC. The laptop PC includes two chassis and a hinge mechanism (not shown). One side face of one of the chassis (hereinafter called a first chassis 101 (FIG. 2)) engages with one side face of the other chassis (hereinafter called a second chassis 102 (FIG. 2)) via the hinge mechanism, and the first chassis is rotatable around the rotary shaft of the hinge mechanism relative to the second chassis. This laptop PC may be called a clamshell-type PC.

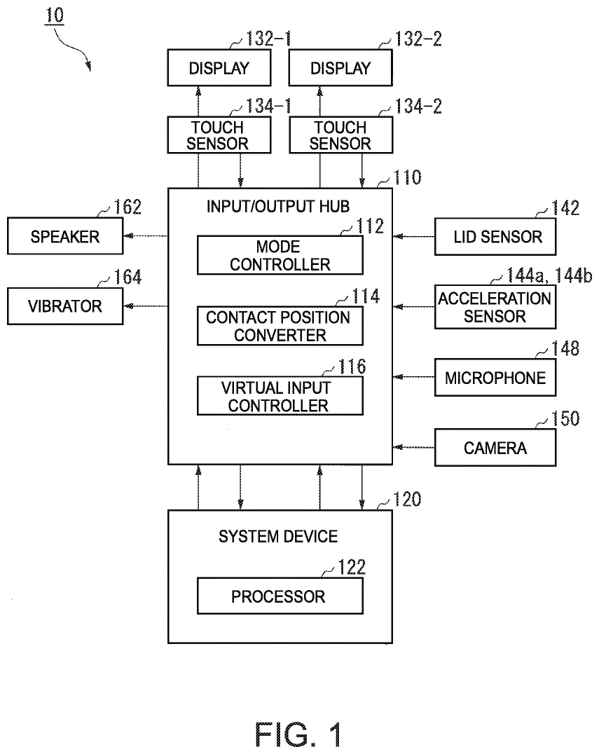

FIG. 1 is a block diagram showing one example of the functional configuration of the information processing apparatus 10 according to examples of the subject disclosure. The information processing apparatus 10 includes an input/output hub 110, a system device 120, displays 132, touch sensors 134, a lid sensor 142, acceleration sensors 144a and 144b, a microphone 148, a camera 150, a speaker 162, and a vibrator 164. Among them, the input/output hub 110, the system device 120, the microphone 148, the camera 150, and the speaker 162 are disposed at either the first chassis 101 or the second chassis 102.

The input/output hub 110 functions as an input/output controller that controls the input/output between the system device 120 and other devices, particularly the plurality of displays 132 and the plurality of touch sensors 134. The input/output hub 110 selects one display mode from a predetermined plurality of types of display modes to implement the selected display mode. The display mode corresponds to an input/output mode, in which a display region of each of the plurality of displays 132 and a part or all of the plurality of display regions is used as the output destination of the screen data of each channel.

For example, the display modes for mutually adjacent two display regions include single display, hybrid display and dual display. A channel refers to the unit of display information displayed at a time. One channel may also be referred to as one system. For example, when the display information is a moving image, one channel corresponds to one stream. When the display information is a still image, one channel corresponds to one frame. The screen of one channel includes one or a plurality of windows, and each window includes one or more frames of images.

The windows may be created by executing the OS, an application program, or other programs. The display mode presented at a time includes one or more screen regions, and each screen region is a region to display an image of each channel. Each screen region includes a display region of one display 132 or each of the plurality of displays 132. The display regions of the displays 132 are independently controllable by the input/output hub 110 or the system device 120 to display an image. Each display region is superimposed on a detection region of the corresponding touch sensor 134. This means that each screen region includes a detection region superimposed on the display region included in the screen region.

The input/output hub 110 is the input/output controller including a mode controller 112, a contact position converter 114, and a virtual input controller 116. The mode controller 112 selects one of a plurality of predetermined display modes based on various types of information. In one example, the mode controller 112 uses the posture of the chassis supporting two display regions as the information to select the display mode. Examples of the display mode are described later.

The contact position converter 114 converts the coordinates of a contact position indicated by contact position data that is input from the detection regions of the touch sensors 134-1 and 134-2 to the coordinates in the screen region in accordance with the display mode selected by the mode controller 112. The contact position converter 114 then outputs the contact position data indicating the converted contact position to the system device 120. Whether or not to convert the coordinates of the contact position and the mapping of coordinate conversion at the contact position depend on the display mode. An example of the processing by the contact position converter 114 will be described later.

When the mode controller 112 selects hybrid display as the display mode, the virtual input controller 116 controls to display an image of a predetermined input unit (e.g., of a keyboard) at a virtual input region set beforehand. When the contact position data indicating the position in the region of displaying a component (e.g., character key) of the input unit as the contact position is input from the touch sensor 134, the virtual input controller 116 creates an operation signal (e.g., a key operation signal) indicating the operation to the component, and outputs the created operation signal to the system device 120. The virtual input region is specified by the position of the origin and the size (resolution) of the virtual input region.

The system device 120 includes at least one processor 122. The processor 122 executes the OS to provide basic functions. In this description, “executing a program” means an operation in accordance with an instruction written in the program (including the OS and application programs). The basic functions include provision of a standard interface to the application programs (APs) and management of various types of resources in the system device 120 and in other hardware (including the input/output hub 110) connected to the system device 120. The processor 122 is able to execute other programs (including APs) on the OS.

In this description “executing a program on an OS” means that execution of the OS provides an interface and a resource to the program and the program is executed based on the provided interface and resource. In the following description, the execution of an OS by a processor and the execution of another program on the OS for any processing are called “execution in accordance with the OS”. The processor 122 may acquire screen data in accordance with the execution of the OS. In one example, the processor 122 may execute the OS or an AP to create screen data or to receive screen data from other devices. The processor 122 outputs the acquired screen data to the input/output hub 110.

The processor 122 may receive contact position data from the input/output hub 110 and execute the processing based on the input contact position data. The processor 122 may control the execution of an AP that is instructed by the input contact position data. The display 132 has a display region to display an image indicated by the screen data input from the input/output hub 110. The display 132 may be any display device, such as a liquid crystal display (LCD) or an organic electro-luminescence display (OLED).

FIG. 1 shows an example of the two displays 132. These two displays 132 are distinguished as displays 132-1 and 132-2. These displays 132-1 and 132-2 are disposed on the surfaces of the first chassis 101 and the second chassis 102, respectively (FIG. 2). In other words, the first chassis 101 and the second chassis 102 function as supports to support the displays 132-1 and 132-2, respectively.

The touch sensors 134 have a detection region to detect a contact with an object (including a part of a human body). The touch sensors 134 may be based on any operating principle, including a resistance film type, a source acoustic wave type, an infrared type, and a capacitive type. The touch sensors 134 output the contact position data indicating the contact position in the detection region where a contact is detected to the input/output hub 110.

FIG. 1 shows an example of the two touch sensors. These two touch sensors 134 are distinguished as touch sensors 134-1 and 134-2. The touch sensors 134-1 and 134-2 are integral with the displays 132-1 and 132-2, respectively, to form touch panels. The display region of each of the displays 132-1 and 132-2 is superimposed on the detection region of the corresponding touch sensor 134-1, 134-2.

The lid sensor 142 is to detect an opening/closing state of the first chassis 101 relative to the second chassis 102. In one example, the lid sensor 142 includes a magnetic sensor to detect the magnetic field surrounding it. While one of the chassis (e.g., the first chassis 101) includes the lid sensor 142, the other chassis (e.g., the second chassis 102) includes a permanent magnet (not shown) at a position opposed to the lid sensor 142 when the first chassis 101 is closed to the second chassis 102. The lid sensor 142 outputs a magnetic-field intensity signal indicative of the intensity of the detected magnetic field to the input/output hub 110.

In certain examples, the mode controller 112 of the input/output hub 110 determines that the first chassis 101 is closed to the second chassis 102 when the magnetic-field intensity indicated by the magnetic-field intensity signal from the lid sensor 142 is equal to or greater than a predetermined threshold of the intensity. The mode controller 112 determines that the first chassis 101 is open relative to the second chassis 102 when the magnetic-field intensity is less than the predetermined threshold of the intensity.

The acceleration sensors 144a and 144b are triaxial acceleration sensors with mutually orthogonal three detection axes. These acceleration sensors 144a and 144b are disposed at the first chassis 101 and the second chassis 102, respectively. This means that the detection axes of the acceleration sensor 144a and the first chassis 101 have a fixed positional relationship and the detection axes of the acceleration sensor 144b and the second chassis 102 have a fixed positional relationship.

The mode controller 112 calculates the angle θ based on the direction of the gravity component of the acceleration detected by the acceleration sensor 144a and the direction of the gravity component of the acceleration detected by the acceleration sensor 144b. The angle θ is an angle formed by the surface of the first chassis 101 and the surface of the second chassis 102. In one example, the mode controller 112 may set the weighted time average of the acceleration that has been detected as the gravity component. For the weighted time average, the weighting factor is set so that a component of the acceleration closer to the current time is larger.

The mode controller 112 may determine the posture mode at that time based on the angle θ. The posture includes one or both of the shape and the orientation. The mode controller 112 may determine the posture mode based on the orientation of the information processing apparatus 10 in addition to the angle θ. The angle θ or the posture mode can be used as an index indicating the posture of the chassis made up of the first chassis 101 and the second chassis 102 that support the displays 132-1 and 132-2, respectively. Each posture mode corresponds to a different display region opposed to the user and a different orientation of the display region, and so may assume a different usage mode. The mode controller 112 may refer to the determined posture mode and determine a display mode.

The microphone 148 collects sound coming from the surroundings and outputs an acoustic signal indicative of the intensity of the collected sound to the input/output hub 110. Under the control of the system device 120, the input/output hub 110 outputs the acoustic signal input from the microphone 148 to the system device 120. The camera 150 captures an image of an object in the visual field and outputs image data indicative of the captured image to the input/output hub 110. The speaker 162 reproduces sound based on the acoustic signal input from the input/output hub 110. Under the control of the system device 120, the input/output hub 110 outputs the acoustic signal input from the system device 120 to the speaker 162. The vibrator 164 generates vibrations based on a vibration signal input from the input/output hub 110. Under the control of the system device 120, the vibrator 164 outputs the vibration signal input from the system device 120 to the vibrator 164.

The information processing apparatus 10 may include one or both of a communication module (not shown) and an input/output interface (not shown). The communication module connects to a network by wire or wirelessly and exchanges various types of data with the other devices connected to the network. The communication module transmits transmission data input from the system device 120 to other devices via the input/output hub 110 and outputs the received data received from the other devices to the system device 120. The input/output interface connects to other devices by wire or wirelessly to enable exchanging of various types of data with the other devices. The communication module connects to a communication network via the input/output hub 110, and transmits the transmission data input from the system device 120 to other devices connected to the network and outputs the data received from the other devices to the system device 120.

The input/output hub 110 may include an input unit that is different from the touch sensors 134-1 and 134-2. This different input unit creates an operation signal in accordance with the received user's operation, and outputs the created operation signal to the system device 120 via the input/output hub 110. The different input unit may be in the form other than the touch sensor, such as a mouse, a keyboard, or a pointing stick.

FIG. 2 describes an example of the display mode according to the subject disclosure. FIG. 2 shows an example of the information processing apparatus 10 having two display regions. The single display is a display mode, in which screen data of one channel input from the system device 120 is output to one screen region made up of both of the display regions of the displays 132-1 and 132-2 that are spatially adjacent to each other. FIG. 2 shows the example where the input/output hub 110 sets one screen region made up of the display regions of the displays 132-1 and 132-2 to display one image Im11.

The dual display is a display mode, in which screen data of each channel input from the system device 120 is output to the display region of the corresponding display 132-1 or 132-2 as a single screen region. FIG. 2 shows the example where the input/output hub 110 sets one screen region made up of the display region of the display 132-1 to display an image Im21 and the other screen region made up of the display region of the display 132-2 to display an image Im22. The double display is a display mode included in multiple display, and the number of the display regions is limited to two.

The hybrid display is a display mode, in which screen data of one or more channels input from the system device 120 is output to both or a part of the display regions of the displays 132-1 and 132-2 that are spatially adjacent to each other as one screen region, and another screen data, which the input/output hub 110 independently obtains, is output to another part of the display regions of the displays 132-1 and 132-2 as the other screen region. That is, the one screen region displays an image based on the screen data acquired under the control of the OS, and the other screen region displays an image based on the screen data independently acquired that is not under the control of the OS. The hybrid display is different from the single display or the dual display in that an image based on screen data acquired that is not under the control of the OS is displayed. The single display or the dual display does not display an image based on screen data acquired that is not under the control of the OS. In the following description, screen data that is not under the control of the OS may be called outside-system screen data, and an image based on such data may be called an outside-system image.

FIG. 2 shows the example where the input/output hub 110 sets the display region of the display 132-1 as one screen region to display an image Im11, and sets the display region of the display 132-2 as a different screen region. This different screen region is set as a virtual input region to receive data from the virtual input controller 116. The display region of the display 132-2 displays an image Im12 representing a keyboard that is one example of the outside-system image. The keyboard is an example of the input unit to receive user's operation. The display region of the display 132-2 is a region surrounded by the detection region of the touch sensor 134-2. When receiving contact data indicating a contact position in the display region of the keys making up the keyboard, the virtual input controller 116 creates an operation signal similar to the operation signal that is created when the user presses the key. The virtual input controller 116 outputs the created operation signal to the system device 120. The user may touch the image Im12 representing the keyboard, and is allowed to implement the input operation similar to with the keyboard operation. In the following description, an image indicating the region to independently accept the input operation as in the image Im12 is called a virtual input image, and data indicating the image is called virtual input image data. As in the example of FIG. 2, the virtual input image may be implemented as an image that virtually represents the input unit.

Each of the three types of display modes as stated above may be further divided into landscape view and portrait view. The landscape view is the display mode to place images of one channel or two channels in the horizontally long direction on the entire display region (hereinafter called the full display region) made up of two display regions. The horizontally long direction refers to the direction such that the longitudinal direction of the full display region extends horizontally. The portrait view is the display mode to place images of one channel or two channels in the vertically long direction on the full display region. The vertically long direction refers to the direction such that the longitudinal direction of the full display region extends vertically. The horizontal and vertical directions refer to the left-right direction of a user facing the information processing apparatus 10 and the direction orthogonal to the left-right direction, respectively.

The mode controller 112 then performs known image recognition processing to the image data input from the camera 150 to recognize an image representing the portrait of the user facing the device, and determines the direction of the device relative to the front face of the user based on the recognized portrait image. More specifically, the mode controller 112 performs the image recognition processing to estimate the region representing user's body parts (e.g., the chest, the head and the like). The mode controller 112 refers to imaging parameters set beforehand to determine the front direction relative to the user based on the positions of representative points (e.g., the eyes, the nose, the mouth, the ears, the roots of the upper arms, the root of the neck and the like) in each region of the estimated body part, and determines the direction orthogonal to the front direction as the left-right direction, i.e., the horizontal direction. The imaging parameters include parameters indicating the relationship between the pixels of the captured image and the direction relative to the optical axis of the camera 150, and parameters indicating the positional relationship between the optical axis of the camera 150 and the display regions of the display 132-1 and 132-2.

The mode controller 112 makes a determination about whether the display mode is set at the landscape view or the portrait view based on the direction of the information processing apparatus 10 that is the direction of the first chassis 101 or the second chassis 102 relative to the front face of the user. When the weight of the second chassis 102 is larger than that of the first chassis 101, the second chassis 102 having larger weight can be used as the reference for the determination. In one example, when the longitudinal direction of the surface of the second chassis 102 is in the vertical direction or is closer to the vertical direction than the horizontal direction, the mode controller 112 sets the display mode as the landscape view. In another example, when the longitudinal direction of the surface of the second chassis 102 is in the horizontal direction or is closer to the horizontal direction than the vertical direction, the mode controller 112 sets the display mode as the portrait view.

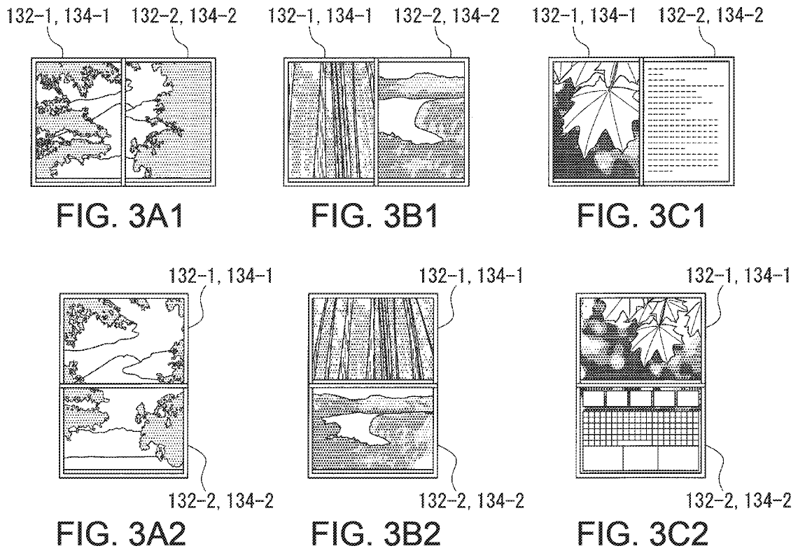

Next the following describes an example of the landscape view and the portrait view. FIGS. 3A1-3C2 show examples of the landscape views and the portrait views according to the subject disclosure. FIG. 3A1 and FIG. 3A2 show examples of the landscape view and the portrait view in the single display. In the example shown in FIG. 3A1, the full display region made up of the display regions of the displays 132-1 and 132-2 is placed horizontally, and shows one frame of image matching with the size and the direction of the full display region.

In the example shown in FIG. 3A2, the full display region made up of the display regions of the displays 132-1 and 132-2 is placed vertically, and shows one frame of image matching with the size and the direction of the full display region. FIG. 3B1 and FIG. 3B2 show examples of the landscape view and the portrait view in the dual display.

In the example shown in FIG. 3B1, the full display region made up of the display regions of the displays 132-1 and 132-2 is placed horizontally. In this case, the display region of each of the displays 132-1 and 132-2 shows one frame of image (two frames in total) matching with the size and the direction (vertical direction) of the display region. The display regions of the displays 132-1 and 132-2 display different images that are based on screen data acquired from the system device 120 and are placed vertically.

In the example shown in FIG. 3B2, the full display region made up of the display regions of the displays 132-1 and 132-2 is placed vertically. In this case, the display region of each of the displays 132-1 and 132-2 shows one frame of image (two frames in total) matching with the size and the direction (horizontal direction) of the display region. The display regions of the displays 132-1 and 132-2 display different images that are based on screen data acquired from the system device 120 and are placed horizontally.

FIG. 3C1 and FIG. 3C2 show examples of the landscape view and the portrait view in the hybrid display. In the example shown in FIG. 3C1, the full display region made up of the display regions of the displays 132-1 and 132-2 is placed horizontally. In this case, the display region of each of the displays 132-1 and 132-2 shows one frame of image (two frames in total) matching with the size and the direction (vertical direction) of the display region. The display regions of the displays 132-1 and 132-2 vertically display an image based on screen data acquired from the system device 120 and an image based on screen data that the input/output hub 110 acquires independently and stores beforehand as the screen data, respectively.

In the example shown in FIG. 3C2, the full display region made up of the display regions of the displays 132-1 and 132-2 is placed vertically. In this case, the display region of each of the displays 132-1 and 132-2 shows one frame of image (two frames in total) matching with the size and the direction (horizontal direction) of the display region. The display regions of the displays 132-1 and 132-2 horizontally display an image based on screen data acquired from the system device 120 and an image of keyboard that the input/output hub 110 acquires independently as the screen data, respectively. The keyboard image means that the display region of the display 132-2 is set as the virtual input region.

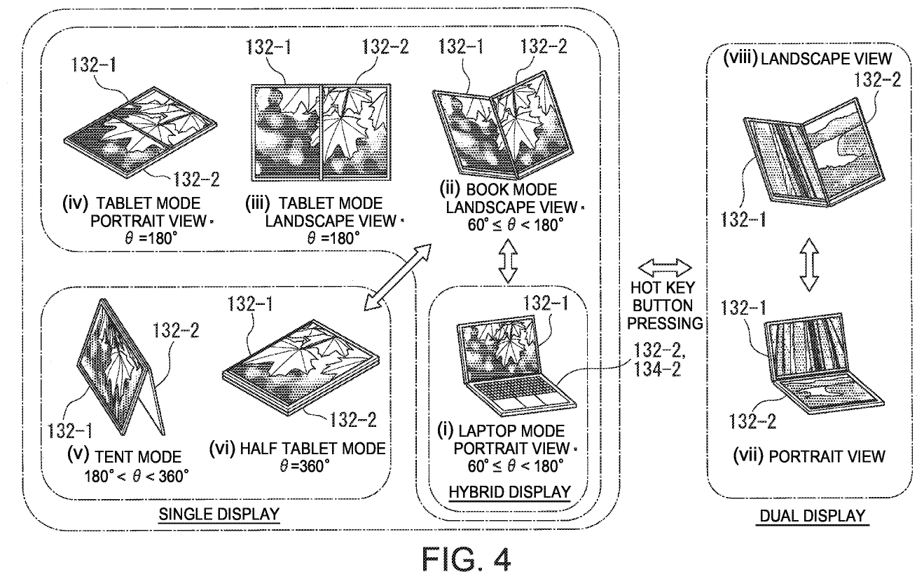

FIG. 4 explains an example of the transition of the display mode according to the subject disclosure. The operation mode includes a posture mode and a display mode. The display mode has a screen region including one or more display regions and a detection region corresponding to each of the display regions. The posture mode is determined based on the angle θ between the first chassis 101 and the second chassis 102 and the orientation of the information processing apparatus 10.

In the example shown in FIG. 4, when the angle θ is equal to or greater than 60° and less than 180° and the longitudinal direction of the second chassis 102 is in the horizontal direction or is closer to the horizontal direction than the vertical direction, the mode controller 112 determines that the posture mode is (i) laptop mode. In this case, the mode controller 112 determines the display mode as the hybrid display in the portrait view. The mode controller 112 controls to display a horizontally long image on the display region of the display 132-1, and displays an image of horizontally long keyboard on the display region of the display 132-2 as a virtual input image. The virtual input controller 116 specifies a component (e.g., a key) displayed in the display region that includes a contact position indicated by the contact position data input from the touch sensors 134-2. The virtual input controller 116 creates an operation signal indicating an operation to the specified component and outputs the created operation signal to the system device 120. The laptop mode is the most typical posture mode for the laptop PC.

When the angle θ is equal to or greater than 60° and less than 180° and the longitudinal direction of the second chassis 102 is in the vertical direction or is closer to the vertical direction than the horizontal direction, the mode controller 112 determines that the posture mode is (ii) book mode and that the display mode is the single display in the landscape view. In this case, the mode controller 112 controls to display a horizontally long image on the full display region made up of the display regions of the displays 132-1 and 132-2.

When the angle θ is 180° and the longitudinal direction of the second chassis 102 is in the vertical direction or is closer to the vertical direction than the horizontal direction, the mode controller 112 determines that the posture mode is (iii) tablet mode and that the display mode is the single display in the landscape view. In this case, the mode controller 112 controls to display a horizontally long one image on the screen region made up of the display regions of the displays 132-1 and 132-2.

When the angle θ is 180° and the longitudinal direction of the second chassis 102 is in the horizontal direction or is closer to the horizontal direction than the vertical direction, the mode controller 112 determines that the posture mode is (iv) tablet mode, and that the display mode is the single display in the portrait view. In this case, the mode controller 112 controls to display a vertically long one image on the full screen region made up of the display regions of the displays 132-1 and 132-2.

When the angle θ is larger than 180° and less than 360°, the mode controller 112 determines, irrespective of the orientation of the second chassis 102, that the posture mode is (v) tent mode, and that the display mode is the single display in the landscape view. In this case, the mode controller 112 controls to display a horizontally long image on the full screen region made up of the display regions of the displays 132-1 and 132-2.

When the angle θ is 360°, the mode controller 112 determines, irrespective of the orientation of the second chassis 102, that the posture mode is (vi) half tablet mode, and that the display mode is the single display. In this case, the mode controller 112 controls to display an image on the display region of the display that is the display of the chassis having the surface directed to the top relative to its lateral faces between the displays 132-1 and 132-2 (in the example of FIG. 4, the display 132-1). Note here that when the longitudinal direction of the surface of the second chassis 102 is in the horizontal direction or is closer to the horizontal direction than the vertical direction, the mode controller 112 controls to display the image to be horizontally long on the display region. In this case, the orientation of the full display region is vertically long, and the mode controller 112 stops the display of an image on the display region of the other display 132-2. When the longitudinal direction of the surface of the second chassis 102 is in the vertical direction or is closer to the vertical direction than the horizontal direction, the mode controller 112 controls to display the image to be vertically long on the display region. In this case, the orientation of the full display region is horizontally long, and the mode controller 112 stops the display of an image on the display region of the other display 132-2.

When the posture mode is (i) laptop mode, (ii) book mode, or (iii), (iv) tablet mode, the mode controller 112 may change the display mode between the single display, the hybrid display and the dual display in accordance with a predetermined operation signal from the input unit (not shown). The predetermined operation signal may be any one of the operation signal that is input in response to the pressing of a dedicated button (switching button), the operation signal that is input in response to the pressing of the hot key, and the like. These buttons may be a dedicated component or an image for operation that is displayed in a predetermined region (e.g., a quadrangular region in contact with one corner of the display region of the display 132-2) in the display region of the display 132-1, 132-2. The hot key is a specific single key or a combination of a plurality of keys that are a part of the keys of the keyboard to designate a certain function. The virtual input controller 116 may display this image for operation regardless of the display mode. The virtual input controller 116 may display the image for operation within a predetermined range (e.g., 1 to 2 cm) from the predetermined region and during a period of detecting the approach of an object (e.g., the user's finger) and may not display the image during other period.

For the dual display as the display mode, when the longitudinal direction of the surface of the second chassis 102 is in the horizontal direction or is closer to the horizontal direction than the vertical direction, the mode controller 112 determines it as (vii) portrait view. When the longitudinal direction of the full display region is in the vertical direction or is closer to the vertical direction than the horizontal direction, the mode controller 112 determines it as (viii) landscape view.

When the posture mode is (v) tent mode, the mode controller 112 may set the screen region to display one channel of image as the display region of either the display 132-1 or the display 132-2 (e.g. display 132-1), and set the other display (e.g., the display 132-2) outside the range of the screen region.

When the posture mode is (i) laptop mode, the mode controller 112 may change the display mode between the hybrid display and the single display in response to inputting of a predetermined operation signal (e.g., pressing of a button).

When the angle θ is larger than 0° and less than 60°, the mode controller 112 may determine the posture mode as closed mode, and stop the display of an image on the display 132-1, 132-2 as well as the detection of a contact position by the touch sensors 134-1 and 134-2. In that case, the mode controller 112 may determine the operating mode as the system as a sleep mode, and output the operation control signal indicative of the sleep mode to the system device 120. When receiving the operation control signal indicative of the sleep mode from the mode controller 112, the system device 120 changes the operation mode to the sleep mode and stops outputting of various types of screen data. When the angle θ is 60° or more, the mode controller 112 may determine the operating mode as the system as normal mode, and output the operation control signal indicative of the normal mode to the system device 120. When receiving the operation control signal indicative of the normal mode from the mode controller 112, the system device 120 changes the operation mode to the normal mode and resumes outputting of various types of screen data. The range of the angle θ corresponding to these posture modes may be different from the range as the example shown in FIG. 4.

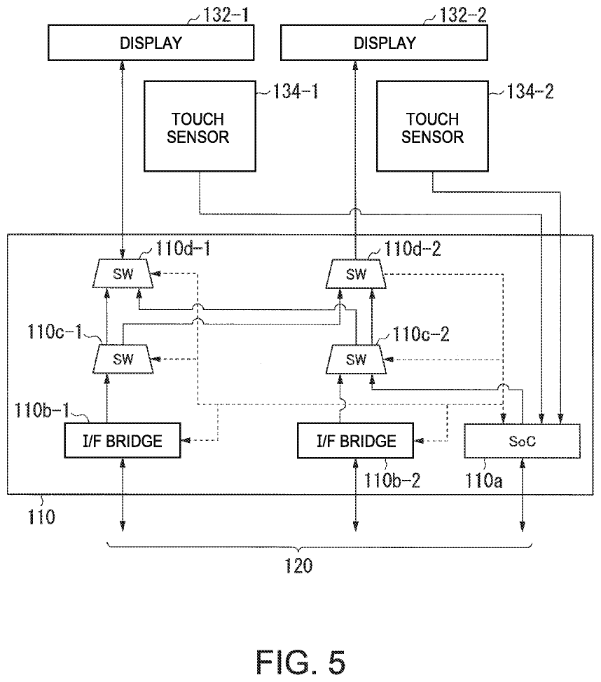

FIG. 5 is a block diagram schematically showing one example of the configuration of the input/output hub according to the subject disclosure. FIG. 5 omits the lid sensor 142, the acceleration sensors 144a, 144b, the microphone 148, the camera 150, the speaker 162, and the vibrator 164.

The input/output hub 110 includes a system-on-a-chip (SoC) 110a, interface (I/F) bridges 110b-1 and 110b-2, and switches 110c-1, 110c-2, 110d-1, and 110d-2. The SoC 110a operates independently of the system device 120 to control the output of screen data to the displays 132-1, 132-2, and the input of contact position data from the touch sensors 134-1, 134-2.

The SoC 110a is an integrated circuit that operates independently of the system device 120 and serves as a microcontroller. The SoC 110a includes a processor and a storage medium, such as a dynamic random-access memory (DRAM). The SoC 110a reads firmware stored in the storage medium beforehand, executes the processing instructed by commands written in the read firmware, and implements the functions of the mode controller 112, the contact position converter 114 and the virtual input controller 116.

The SoC 110a cooperates with the I/F bridges 110b-1 and 110b-2 and the switches (SW) 110c-1, 110c-2, 110d-1, and 110d-2 to implement the function of the mode controller 112 (FIG. 2). The mode controller 112 determines a display mode based on the detection signal input from various sensors as described above. Each of the display modes includes one set or two sets of display regions. Each screen region includes any one of or both of the display regions of the display 132-1 and the display 132-2. Depending on the display mode, any one of or both of the size and the orientation of each screen region may differ. Depending on the size of the screen region or the orientation of an image, any one of or the group of at least two of the size, the orientation and the position of an image to be displayed on each display region may differ. The position is indicated with the position of the representative point (e.g., the starting point) of the display region where the image is allocated in the screen region. An example of the display mode is described later.

The mode controller 112 specifies an image corresponding to the determined display mode, the size of each image, the orientation, and the position of the image in the screen region. The mode controller 112 creates an image request signal indicating a request for an image having a specified size and orientation for each channel of the image. The mode controller 112 outputs the image request signal created for each channel to the I/F bridges 110b-1 and 110b-2. The I/F bridges 110b-1 and 110b-2 correspond to the images of the first channel and the second channel, respectively.

The mode controller 112 outputs an output control signal to the switches 110c-1 and 110c-2. The output control signal indicates whether or not to output the screen data to the corresponding switch 110d-1, 110d-2 for each channel forming the determined display mode. The mode controller 112 specifies allocation information indicating the size, the orientation and the position of an allocating part to allocate images indicated by the screen data in the display region of each of the displays 132-1 and 132-2 in the screen region making up the determined display mode. The mode controller 112 outputs an allocation control signal indicating the allocation information specified for each of the display regions of the displays 132-1 and 132-2 to the switches 110d-1 and 110d-2, respectively.

The I/F bridges 110b-1 and 110b-2 are interfaces that bridge-connect to the system device 120 with a predetermined data input/output format to input and output various types of data. Examples of the data input/output format available include formats specified by the mobile industry processor interface (MIPI) (registered trademark) and the embedded display port (eDP) (registered trademark). The I/F bridges 110b-1 and 110b-2 receive image request signals from the SoC 110a and outputs them to the system device 120. Examples of the image request signal available include EDID specified by Video Electronics Standards Association (VESA) and Extended Display Identification Data (EDID) standard.

The system device 120 includes two display ports. These display ports connect to the I/F bridges 110b-1 and 110b-2. The system device 120 creates screen data indicating an image having the size and the orientation designated by the input image request signal, and outputs the created screen data to the I/F bridge connected to the display port corresponding to the channel designated by the image request signal via the display port. This means that the system device 120 enables outputting of screen data of one channel or two channels at one time.

The I/F bridges 110b-1 and 110b-2 receive screen data from the system device 120, and output the data to the switches 110c-1 and 110c-2, respectively. The switch 110c-1 controls whether or not to output the screen data from the I/F bridge 110b-1 to the switches 110d-1 and 110d-2 based on the output control signal from the SoC 110a. The switch 110c-2 controls whether or not to output the screen data from the I/F bridge 110b-2 as well as the outside-system screen data from the SoC 110a to the switches 110d-1 and 110d-2 based on the output control signal from the SoC 110a.

The switch 110d-1 specifies the size, the orientation and the position of an allocating part to the display 132-1, which is designated by the allocation control signal from the SoC 110a, of an image indicated by the screen data input from the switches 110c-1 and 110c-2. The switch 110d-1 extracts the specified allocating part, and outputs the screen data indicating the extracted allocating part to the display 132-1.

Similarly to the switch 110d-1, the switch 110d-2 also specifies the size, the orientation and the position of an allocating part to the display 132-2, which is designated by the allocation control signal from the SoC 110a, of an image indicated by the screen data input from the switches 110c-1 and 110c-2. The switch 110d-2 extracts the specified allocating part, and outputs the screen data indicating the extracted allocating part to the display 132-2. Note here that the series of switches shown as an example in FIG. 5 just shows the concept of the functional configuration, and it does not require the configuration with components corresponding to these blocks shown in the drawing. In one example, these switches 110c-1, 110c-2, 110d-1, and 110d-2 may have a function other than simple switching function, such as having a buffer for screen synthesis. The set of two or more switches, e.g., the set of the switches 110c-1 and 110c-2 or the set of the switches 110d-1 and 110d-2, may be implemented with a single component. Some or all of these switches, e.g., the switches 110c-1 and 110c-2, may be integrated as a part of the I/F bridges 110b-1 and 110b-2, respectively.

Each of the touch sensors 134-1 and 134-2 includes a touch controller (not shown). The touch controller controls the detection of a contact position in the detection region of the corresponding touch sensor 134-1, 134-2. In one example, the touch controller controls the sensitivity based on the detection control signal input from the SoC 110a. The touch controller outputs the contact position data indicating the contact position detected in the corresponding detection region to the SoC 110a. The touch controller connects to the SoC 110a via a serial bus of predetermined standard (e.g., I2C bus).

The contact position converter 114 converts the coordinates of a contact position detected from the detection region by the touch sensors 134-1 and 134-2 to the coordinates in the screen region in the display mode selected by the mode controller 112. The contact position converter 114 then outputs the contact position data indicating the contact position with the converted coordinates to the system device 120. Whether or not to convert the coordinates of the contact position and the mapping of conversion depend on the display mode.

For the example shown in FIG. 3A1, the contact position converter 114 converts the coordinates of a contact position in the detection region in the horizontally long direction of the touch sensor 134-2 that is superimposed on the display region of the display 132-2 to the coordinates in the detection region in the vertically long direction, and then converts the coordinates to the coordinates in the right half region in the drawing of the screen region in the horizontally long direction made up of the entire detection region of the touch sensors 134-1 and 134-2. For the example shown in FIG. 3C2, the detection regions of the touch sensors 134-1 and 134-2 are mutually independent screen regions, and the orientation does not change before and after the conversion. In this example, the contact position converter 114 does not convert a contact position in the detection region by the touch sensor 134-2, and uses the contact position without the conversion.

When the display mode determined by the mode controller 112 is a hybrid display mode, the virtual input controller 116 creates virtual input image data and outputs the created virtual input image data to the mode controller 112 as an example of the outside-system screen data. The mode controller 112 acquires the outside-system screen data and outputs the acquired outside-system screen data to the switch 110c-2. Outside-system display setting information indicating the size, the orientation and the position of the outside-system image is configured in the mode controller 112 beforehand. The mode controller 112 outputs an output control signal to the switch 110c-2. The output control signal indicates whether or not to output the outside-system screen data. The mode controller 112 specifies outside-system display allocation information indicating the size, the orientation and the position of an allocating part to allocate the outside-system image in the display regions of the displays 132-1 and 132-2 in the full display region. The mode controller 112 outputs an allocation control signal indicating the outside-system display allocation information specified for each of the display regions of the displays 132-1 and 132-2 to the switches 110d-1 and 110d-2, respectively.

The virtual input controller 116 detects a component of the input unit in the display region that includes a contact position in the contact region indicated by the contact position data from each of the touch sensors 134-1 and 134-2. The virtual input controller 116 outputs an operation signal indicating an operation to the detected component to the system device 120. The input/output hub 110 includes an input/output interface (e.g., a USB port) to connect to the system device 120 via a serial bus in a predetermined format (e.g., universal serial bus (USB)). The SoC 110a, various types of sensors (e.g., the lid sensor 142, the acceleration sensors 144a and 144b, the microphone 148, and the camera 150), and various types of actuators (e.g., the speaker 162 and the vibrator) connect to the input/output interface.

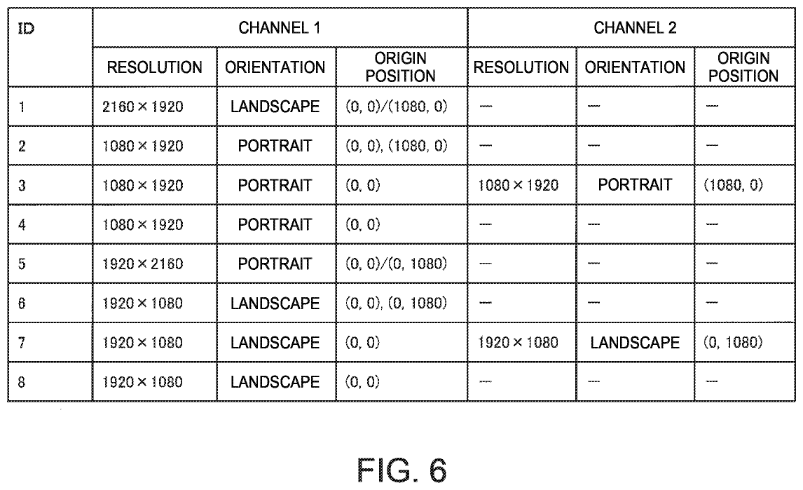

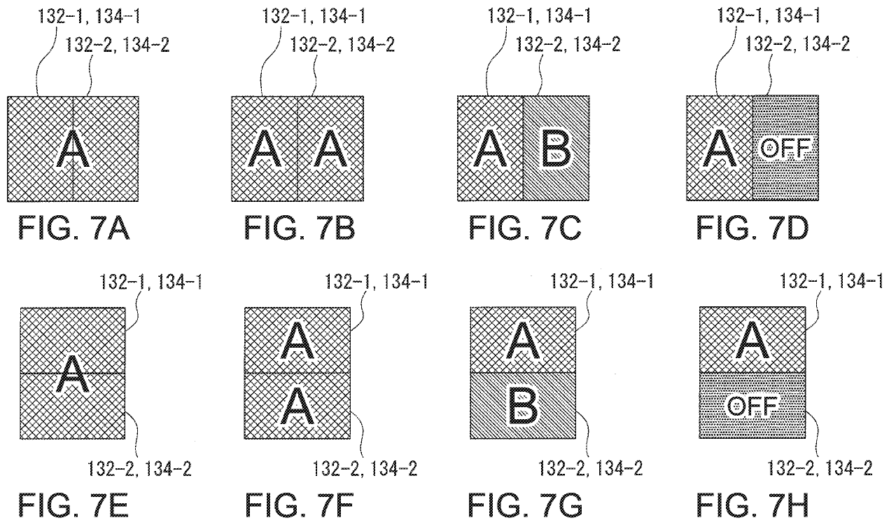

Referring next to FIG. 6 and FIGS. 7A-7H, the following describes an example of the control of display modes according to the subject disclosure. FIG. 6 shows an example of a control table according to the subject disclosure. FIGS. 7A-7H shows examples of the display modes according to the subject disclosure. The control table is data indicating setting information for each display mode. The SoC 110a stores the control table beforehand. The mode controller 112 refers to the control table to specify setting information on the determined display mode, and creates an output control signal and an allocation control signal as described above based on the specified setting information. The contact position converter 114 converts a contact position based on the setting information specified by the mode controller 112.

As shown in FIG. 6, the control table contains the setting information on the display mode for each identifier (ID). The ID is an identifier indicating each display mode. The setting information indicates the size, the orientation and the position for each of the images of one channel and two channels. The size of the image is expressed as the resolution that is the number of pixels in the horizontal direction and the vertical direction of the screen region made up of the display region(s) of one or two displays. The horizontal direction and the vertical direction indicate the directions of columns and rows of the pixels making up each image.

The setting information designates either the landscape (horizontally long) direction or the portrait (vertically long) direction as the direction of the image. The origin position is the position of the origin that is a representative point of the allocating part to allocate an image for each channel in the display region of the corresponding display. The origin position is expressed as the number of pixels in the horizontal direction and the vertical direction that are reference directions of images in the full display region made up of the display regions of the displays 132-1 and 132-2 as a whole. For channel 1 corresponding to ID1 and ID5, two origin positions are shown while dividing them with the mark “/”. This mark means that the image of channel 1 is divided into a plurality of allocating parts each having the designated origin position, and the divided allocating parts are allocated (distributed) to their corresponding display regions in the display.

For channel 1 corresponding to ID2 and ID6 as well, two origin positions are shown while dividing them with the mark “,”. These two origin positions mean that the image of channel 1 common to the screen regions designated with these origin positions is allocated (copied) to the display regions of the display. The example shown in FIG. 6 shows the case where the display regions of the displays 132-1 and 132-2 have the resolution of 1920 pixels in the horizontal direction×1080 pixels in the vertical direction (hereinafter, 1920×1080). The mode controller 112 configures the setting information (e.g., including information on the resolution) on the display regions of the displays 132-1 and 132-2 beforehand.

FIGS. 7A-7H show display modes corresponding to ID1 to ID8, respectively. In FIGS. 7A-7H, “A”, “B” and “OFF” indicate an image of channel 1, an image of channel 2, and not-displayed, respectively. In FIG. 6, ID1 corresponds to a display mode that is single display in landscape view. The setting information of the display mode with ID1 shows “2160×1920” as the resolution, “landscape” as the orientation, and “(0,0)/(1080,0)” as the origin position of an image of channel 1, and does not include information on an image of channel 2. This information indicates that the image of channel 1 is allocated in the horizontally long direction in the full display region with the origin as the starting point. When the mode controller 112 determines the display mode as single display in the horizontally long direction, the mode controller 112 refers to the setting information corresponding to ID1, creates an image request signal indicating the resolution “2160×1920” and the orientation “landscape”, and outputs the created image request signal to the I/F bridge 110b-1. The mode controller 112 creates an output control signal indicating the output of screen data from the I/F bridge 110b-1 to the switches 110d-1 and 110d-2, and outputs the created output control signal to the switch 110c-1.

The mode controller 112 then refers to the preset setting information on the display region of the display 132-1, and determines, as an allocating part to the display 132-1, a part of the size “1080×1920” starting from the origin (0,0) in the image of the screen data input from the switch 110c-1 and determines the horizontally long direction as the allocation direction of the determined allocating part. The mode controller 112 specifies the origin of the display region of the display 132-1 as the origin of the allocation destination corresponding to the origin (0,0). The mode controller 112 creates an allocation control signal indicating the position of the starting point, the size and the allocation direction at the allocation destination of the determined allocating part to the display 132-1, and outputs the created allocation control signal to the switch 110d-1.

The mode controller 112 determines, as an allocating part to the display 132-2, a part of the size “1080×1920” starting from the coordinates (1080,0) that is the remaining part in the image of the screen data input from the switch 110c-1 and determines the horizontally long direction as the allocation direction of the determined allocating part. The mode controller 112 specifies the origin of the display region of the display 132-2 corresponding to the coordinates (1080, 0) as the origin of the allocation destination. The mode controller 112 creates an allocation control signal indicating the position of the starting point, the size and the allocation direction at the allocation destination of the determined allocating part to the display 132-2, and outputs the created allocation control signal to the switch 110d-2.

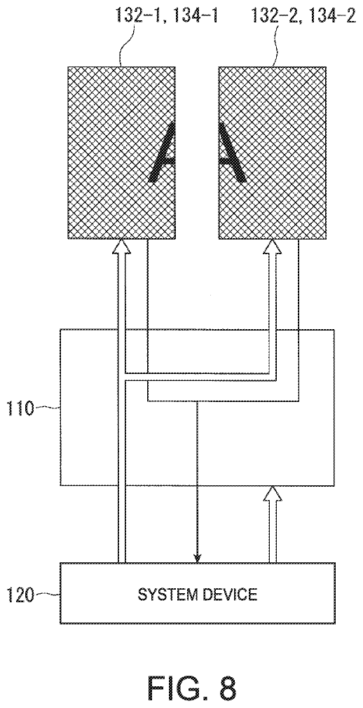

In this way, the switch 110c-1 receives the screen data indicating the image of “2160×1920” in size from the system device 120 via the I/F bridge 110b-1, and outputs the received screen data to the switches 110d-1 and 110d-2 in accordance with the output control signal from the mode controller 112. The switches 110d-1 and 110d-2 extract, from an image indicated by the screen data from the switch 110c-1, an allocating part designated by the allocation control signal from the mode controller 112. The switches 110d-1 and 110d-2 then convert the direction of the extracted allocating part that is extracted according to the allocation control signal to the horizontally long direction, and output the screen data indicating the converted allocating part to the display units 132-1 and 132-2, respectively. As a result, the full display region made up of the display regions of the displays 132-1 and 132-2 as one screen region displays the image of channel 1 in the horizontally long direction (see FIG. 8).

The contact position converter 114 refers to the setting information corresponding to ID1 selected by the mode controller 112, and converts the coordinates of a contact position detected by the touch sensors 134-1 and 134-2 to the coordinates in the screen region of channel 1. The size of this screen region is “2160×1920”, and the direction is landscape. The contact position converter 114 converts the coordinates of a contact position in the horizontally-long contact region indicated by the contact position data from the touch sensor 134-1 to the coordinates in the vertically-long region, and determines the contact position indicated with the converted coordinates as a contact position of channel 1. The contact position converter 114 adds the coordinates (1080, 0) in the screen region of channel 1 corresponding to the origin of the detection region of the touch sensor 134-2 to the coordinates of a contact position in the horizontally-long contact region indicated by the contact position data that is input from the touch sensor 134-2, and determines the contact position indicated with the calculated coordinates. The contact position converter 114 outputs the contact position data indicating the determined contact position to the system device 120. The system device 120 therefore can conduct the processing based on the contact position in the set screen region without dependence on the control of the OS.

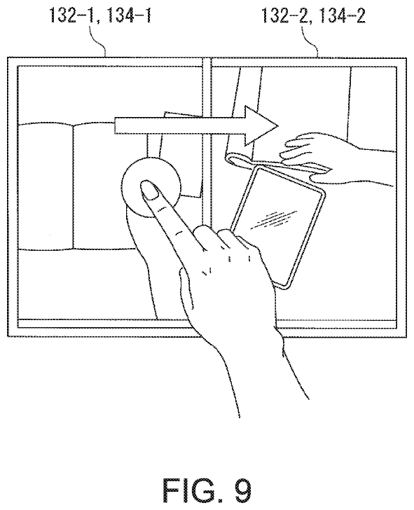

FIG. 9 shows the example where the operation to continuously move a contact position across the detection regions of the touch sensors 134-1 and 134-2 is detected. In this case, the system device 120 implements the processing based on the contact position moving continuously. In one example, the system device 120 displays a cursor linked with the contact position in the screen region while setting the detected contact position as a reference point.

In FIG. 6, ID2 corresponds to a display mode that is dual display in landscape view. The setting information of the display mode with ID2 shows “1080×1920” as the resolution, “portrait” as the orientation, and “(0,0),(1080,0)” as the origin position of an image of channel 1, and does not include information on an image of channel 2. This information indicates that the image of channel 1 is allocated in the vertically long direction to the display regions of the displays 132-1 and 132-2 with these origins as the starting points. ID2 corresponds to the case where the screen data of one channel is obtained from the system device 120, and the screen data of two channels is not obtained.

The mode controller 112 determines the display mode as dual display in the landscape view. When the screen data of one channel is obtained from the system device 120, the mode controller 112 creates an image request signal indicating the resolution “1080×1920” and the orientation “portrait”, and outputs the created image request signal to the I/F bridge 110b-1. The mode controller 112 creates an output control signal indicating the output of screen data from the I/F bridge 110b-1 to the switches 110d-1 and 110d-2, and outputs the created output control signal to the switch 110c-1.

The mode controller 112 then refers to the preset setting information on the display region of the display 132-1, and determines, as an allocating part to the display 132-1, a part of the size “1080×1920” starting from the origin in the image of the screen data input from the switch 110c-1, i.e., the entire image, and determines the vertically long direction as the allocation direction of the determined allocating part. The mode controller 112 specifies the origin of the display 132-1 as the starting point of the allocation destination corresponding to the origin (0,0).

The mode controller 112 creates an allocation control signal indicating the position of the starting point, the size and the allocation direction at the allocation destination of the determined allocating part to the display 132-1, and outputs the created allocation control signal to the switch 110d-1.

The mode controller 112 determines, as an allocating part to the display 132-2, the entire image of the screen data that is input from the switch 110c-1 and determines the vertically long direction as the allocation direction of the determined allocating part. The mode controller 112 specifies the origin of the display region of the display 132-2 as the starting point of the allocation destination corresponding to the origin (1080,0). The mode controller 112 creates an allocation control signal indicating the position of the starting point, the size and the allocation direction at the allocation destination of the determined allocating part to the display 132-2, and outputs the created allocation control signal to the switch 110d-2.

In this way, the switch 110c-1 receives the screen data indicating the image of “1080×1920” in size from the system device 120 via the I/F bridge 110b-1, and outputs the received screen data to the switches 110d-1 and 110d-2 in accordance with the output control signal from the mode controller 112.

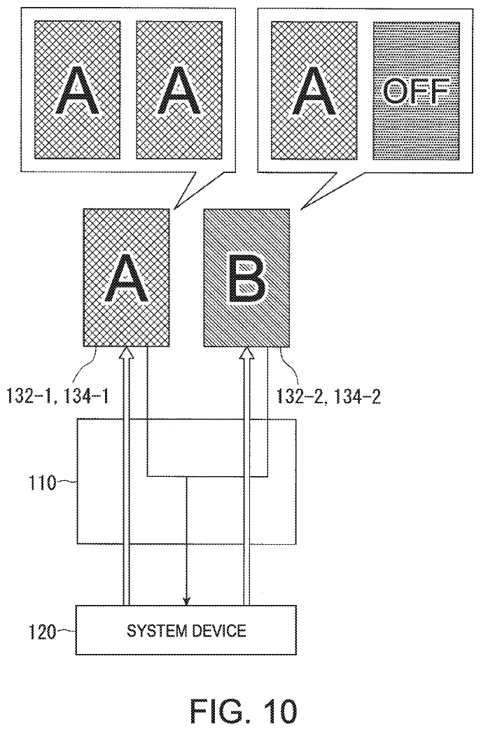

The switches 110d-1 and 110d-2 each specify an image indicated with the screen data input from the switch 110c-1 as an allocating part designated with the allocating control signal input from the mode controller 112. The switches 110d-1 and 110d-2 then keep the specified direction of the allocating part in accordance with the allocating control signal as the vertically long direction, and output the screen data indicating the allocating part to the display units 132-1 and 132-2, respectively. As a result, the display regions of the displays 132-1 and 132-2 as the screen regions display the image of channel 1 in the vertically long direction (see FIG. 10).

The contact position converter 114 refers to the setting information corresponding to ID2 selected by the mode controller 112 and determines the coordinates of the contact positions detected by the touch sensors 134-1 and 134-2 as the coordinates in the screen region of channel 1. The contact position converter 114 therefore does not convert the contact positions indicated with the contact position data input from the touch sensors 134-1 and 134-2, and outputs them as contact position data corresponding to channel 1 to the system device 120 (FIG. 10).

In FIG. 6, ID3 corresponds to a display mode that is dual display in landscape view. The setting information of the display mode with ID3 shows “1080×1920” as the resolution, “portrait” as the orientation, and “(0,0)” as the origin position of an image of channel 1, and shows “1080×1920” as the resolution, “portrait” as the orientation, and “(1080,0)” as the origin position of an image of channel 2. This information indicates that the images of channels 1 and 2 are allocated in the display regions of the displays 132-1 and 132-2, respectively, with these origins as the starting points. ID3 corresponds to the case where the screen data of two channels can be obtained from the system device 120.

The mode controller 112 determines the display mode as dual display in the landscape view. When the screen data of two channels can be obtained from the system device 120, the mode controller 112 creates a first image request signal and a second image request signal each indicating the resolution “1080×1920” and the orientation “portrait”. The mode controller 112 outputs the created first image request signal to the I/F bridge 110b-1, and outputs the created second image request signal to the I/F bridge 110b-2. The mode controller 112 creates a first output control signal indicating the output of screen data from the I/F bridge 110b-1 to the switch 110d-1, and creates a second output control signal indicating the output of screen data from the I/F bridge 110b-2 to the switch 110d-2. The mode controller 112 outputs the created first output control signal to the switch 110c-1, and outputs the created second output control signal to the switch 110c-2.

The mode controller 112 then refers to the preset setting information on the display region of the display 132-1, and determines, as an allocating part to the display 132-1, a part of the size “1080×1920” starting from the origin in the image of the screen data of channel 1 input from the switch 110c-1, i.e., the entire image, and determines the vertically long direction as the allocation direction of the determined allocating part. The mode controller 112 specifies the origin of the display 132-1 as the starting point of the allocation destination corresponding to the origin (0,0).

The mode controller 112 creates an allocation control signal indicating the position of the starting point, the size and the allocation direction at the allocation destination of the determined allocating part to the display 132-1, and outputs the created allocation control signal to the switch 110d-1. The mode controller 112 determines, as an allocating part to the display 132-2, the entire image of the screen data of channel 2 that is input from the switch 110c-2 and determines the vertically long direction as the allocation direction of the determined allocating part. The mode controller 112 specifies the origin of the display 132-2 as the starting point of the allocation destination corresponding to the origin (1080,0). The mode controller 112 creates an allocation control signal indicating the position of the starting point, the size and the allocation direction at the allocation destination of the determined allocating part to the display 132-2, and outputs the created allocation control signal to the switch 110d-2.

In this way, the switch 110c-1 receives the screen data indicating the image of channel 1 of “1080×1920” in size from the system device 120 via the I/F bridge 110b-1, and outputs the received screen data to the switch 110d-1 in accordance with the first output control signal from the mode controller 112. The switch 110c-2 receives the screen data indicating the image of channel 2 of “1080×1920” in size via the I/F bridge 110b-2, and outputs the received screen data to the switch 110d-2 in accordance with the second output control signal from the mode controller 112.

The switch 110d-1 specifies an image indicated with the screen data of channel 1 input from the switch 110c-1 as an allocating part designated with the first allocating control signal input from the mode controller 112, and outputs the screen data indicating the allocating part to the display unit 132-1 while keeping the specified direction of the allocating part in accordance with the first allocating control signal as the vertically long direction.

The switch 110d-2 specifies an image indicated with the screen data of channel 2 input from the switch 110c-2 as an allocating part designated with the second allocating control signal input from the mode controller 112, and outputs the screen data indicating the allocating part to the display unit 132-2 while keeping the specified direction of the allocating part in accordance with the second allocating control signal as the vertically long direction. As a result, the display regions of the displays 132-1 and 132-2 as the screen regions display the images of mutually independent channels 1 and 2 in the vertically long direction (FIG. 10).

The contact position converter 114 refers to the setting information corresponding to ID3 selected by the mode controller 112 and determines the coordinates of the contact positions detected by the touch sensors 134-1 and 134-2 as the coordinates in the screen regions of channels 1 and 2, respectively. The contact position converter 114 therefore does not convert the coordinates of the contact positions indicated with the contact position data input from the touch sensors 134-1 and 134-2, and outputs them as contact position data corresponding to channel 1 and channel 2, respectively, to the system device 120 (FIG. 10).

In FIG. 6, ID4 corresponds to a display mode that is single display in landscape view. The display region of the display 132-2 does not display an image (partial display). The setting information of the display mode with ID4 shows “1080×1920” as the resolution, “portrait” as the orientation, and “(0,0)” as the origin position of an image of channel 1, and does not include setting information on an image of channel 2. This information indicates that the image of channel 1 is allocated in the vertically long direction in the display region of the displays 132-1 as the screen region with the origin as the starting point. ID4 corresponds to a posture mode that does not need to display an image on the display 132-2, e.g., a tent mode or a half tablet mode.

The mode controller 112 determines the display mode as single display in the landscape view. When the posture mode is determined as a tent mode or a half tablet mode, the mode controller 112 creates an image request signal indicating the resolution “1080×1920” and the orientation “portrait”, and outputs the created image request signal to the I/F bridge 110b-1. The mode controller 112 creates an output control signal indicating the output of screen data from the I/F bridge 110b-1 to the switch 110d-1, and outputs the created output control signal to the switch 110c-1.

The mode controller 112 then refers to the preset setting information on the display region of the display 132-1, and determines, as an allocating part to the display 132-1, a part of the size “1080×1920” starting from the origin in the image of the screen data of channel 1 input from the switch 110c-1, i.e., the entire image, and determines the vertically long direction as the allocation direction of the determined allocating part. The mode controller 112 specifies the origin of the display 132-1 as the starting point of the allocation destination corresponding to the origin (0,0).

The mode controller 112 creates an allocation control signal indicating the position of the starting point, the size and the allocation direction at the allocation destination of the determined allocating part to the display 132-1, and outputs the created allocation control signal to the switch 110d-1.

In this way, the switch 110c-1 receives the screen data indicating the image of channel 1 of “1080×1920” in size from the system device 120 via the I/F bridge 110b-1, and outputs the received screen data to the switch 110d-1 in accordance with the output control signal from the mode controller 112.

The switch 110d-1 specifies an image indicated with the screen data of channel 1 input from the switch 110c-1 as an allocating part designated with the first allocating control signal input from the mode controller 112, and outputs the screen data indicating the allocating part to the display unit 132-1 while keeping the specified direction of the allocating part in accordance with the first allocating control signal as the vertically long direction.

As a result, the display region of the display 132-1 as the screen region displays the image of channel 1 in the vertically long direction, and the display region of the display 132-2 does not display an image (FIG. 10). The contact position converter 114 refers to the setting information corresponding to ID4 selected by the mode controller 112 and determines the coordinates of the contact position detected by the touch sensor 134-1 as the coordinates in the screen region of channel 1. The contact position converter 114 therefore does not convert the coordinates of the contact position indicated with the contact position data input from the touch sensor 134-1, and outputs them as contact position data corresponding to channel 1 to the system device 120 (FIG. 10). The contact position converter 114 does not need to operate the touch sensor 134-2 2 having the detection region superimposed on the display area where no image is displayed. The contact position converter 114 may keep the operation of the touch sensor 134-2 or may discard the contact position data input from the touch sensor 134-2.

In FIG. 6, ID5 corresponds to a display mode that is single display in portrait view. The setting information of the display mode with ID5 shows “1920×2160” as the resolution, “portrait” as the orientation, and “(0,0)/(1080,0)” as the origin position of an image of channel 1, and does not include information on an image of channel 2. This information indicates that the image of channel 1 is allocated in the vertically long direction to the full display region with the origin as the starting point.

When the mode controller 112 determines the display mode as single display in the portrait view, the mode controller 112 requests image data indicating an image having the resolution “1920×2160” and the orientation “portrait” as an image of channel 1 from the system device 120 based on ID5 and by the above-stated technique.

The mode controller 112 controls to display the screen data indicating allocating parts having the starting points of (0,0) and (1080, 0) of the image of channel 1 input from the system device 120 in the display regions in the horizontally long direction of the displays 132-1 and 132-2 having the origins (0,0) and (1080, 0) as the starting points. As a result, the full display region made up of the display regions of the displays 132-1 and 132-2 as one screen region displays the image of channel 1 in the vertically long direction.

The contact position converter 114 refers to the setting information corresponding to ID5, and converts the coordinates of contact positions detected by the touch sensors 134-1 and 134-2 to the coordinates in the screen region of channel 1. The contact position converter 114 then outputs the contact position data indicating the coordinates of the determined contact positions to the system device 120.

In FIG. 6, ID6 corresponds to a display mode that is dual display in portrait view. The setting information of the display mode with ID6 shows “1920×1080” as the resolution, “landscape” as the orientation, and “(0,0),(0,1080)” as the origin position of an image of channel 1, and does not include information on an image of channel 2. This information indicates that the image of channel 1 is allocated in the horizontally long direction to the display regions of the displays 132-1 and 132-2 with these origins as the starting points.

When the mode controller 112 determines the display mode as dual display in the portrait view, the mode controller 112 requests image data indicating an image having the resolution “1920×1080” and the orientation “landscape” as an image of channel 1 from the system device 120 based on ID6 and by the above-stated technique.

The mode controller 112 controls to display the entire image of channel 1 input from the system device 120 in the display regions in the horizontally long direction of the displays 132-1 and 132-2 having the origins (0,0) and (1080, 0) as the starting points. As a result, the display regions of the displays 132-1 and 132-2 as the screen regions display the image of channel 1 in the horizontally long direction.

The contact position converter 114 refers to the setting information corresponding to ID6, and does not convert the coordinates of the contact position indicated with the contact position data input from the touch sensors 134-1 and 134-2, and outputs them as contact position data corresponding to channel 1 to the system device 120. In FIG. 6, ID7 corresponds to a display mode that is dual display in portrait view. The setting information of the display mode with ID7 shows “1920×1080” as the resolution, “landscape” as the orientation, and “(0,0)” as the origin position of an image of channel 1, and shows “1920×1080” as the resolution, “landscape” as the orientation, and “(0,1080)” as the origin position of an image of channel 2. This information indicates that the images of channels 1 and 2 are allocated in the display regions of the displays 132-1 and 132-2, respectively, with these origins as the starting points.

When the mode controller 112 determines the display mode as dual display in the portrait view, the mode controller 112 requests image data 1, 2 indicating images 1 and 2 having the resolution “1080×1920” and the orientation “landscape” as images of channels 1 and 2 from the system device 120 based on ID7 and by the above-stated technique.

The mode controller 112 controls to display the entire images 1 and 2 of channels 1 and 2 input from the system device 120 in the display regions of the displays 132-1 and 132-2 having the origins (0,0) and (1080, 0) as the starting points. As a result, the display regions of the displays 132-1 and 132-2 as the screen regions display the images of mutually independent channels 1 and 2 in the horizontally long direction.

The contact position converter 114 refers to the setting information corresponding to ID7, and does not convert the coordinates of the contact position indicated with the contact position data input from the touch sensors 134-1 and 134-2, and outputs them as contact position data corresponding to channels 1 and 2 to the system device 120.

In FIG. 6, ID8 corresponds to a display mode that is single display in portrait view. The setting information of the display mode with ID8 shows “1080×1920” as the resolution, “landscape” as the orientation, and “(0,0)” as the origin position of an image of channel 1, and does not include setting information on an image of channel 2. This information indicates that the image of channel 1 is allocated in the vertically long direction to the display region of the displays 132-1 as the screen region with the origin as the starting point.

The mode controller 112 determines the display mode as single display in the portrait view. When the image display on the display 132-2 is not requested, the mode controller 112 requests image data indicating the resolution “1920×1080” and the orientation “landscape” as an image of channel 1 from the system device 120 based on ID8 and by the above-stated technique.

The mode controller 112 controls to display the entire image input from the system device 120 in the display region of the display 132-1 having the origin (0,0) as the starting point. As a result, the display region of the display 132-1 as the screen region displays the image of channel 1 in the horizontally long direction, and the display region of the display 132-2 does not display an image.

The contact position converter 114 refers to the setting information corresponding to ID8 selected by the mode controller 112, and does not convert the coordinates of the contact position indicated with the contact position data input from the touch sensor 134-1, and outputs them as contact position data corresponding to channel 1 to the system device 120. As described above, the contact position converter 114 may not acquire contact position data from the touch sensor 134-2.

Next the following describes an example of the processing for screen data and contact position data by way of an example of hybrid display as the display mode. The following mainly describes the processing for the virtual input region while referring to the descriptions shown in FIG. 5 to FIG. 10 for other parts.

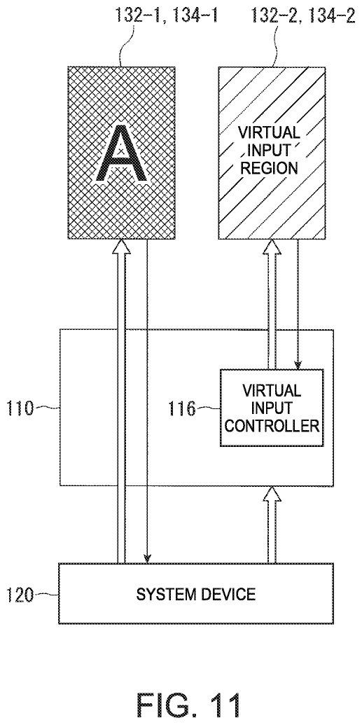

FIG. 11 shows an example where the display region of the display 132-1 displays a vertically-long image of channel 1 acquired from the system device 120, and the display region of the display 132-2 has a virtual input region, so that the full display region is set in the horizontally long direction.

When the mode controller 112 determines the display mode as hybrid display in landscape view, the virtual input controller 116 outputs a virtual input image data, which is set in the virtual input controller beforehand, to the switch 110c-2. The virtual input image data is data indicating a predetermined virtual input region and a virtual input image to be displayed on the entire display region of the display 132-2.

The mode controller 112 refers to the virtual input setting information set in the virtual input controller 116, determines the entire virtual input image as an allocating part to the display 132-2, and determines a predetermined vertically-long direction as the allocation direction of the determined allocating part. The mode controller 112 specifies the origin of the display 132-2 as the starting point of the allocation destination. The mode controller 112 creates a second allocation control signal indicating the position of the starting point, the size and the allocation direction at the allocation destination of the determined allocating part to the display 132-2, and outputs the created second allocation control signal to the switch 110d-2.

The switch 110d-2 specifies a virtual input image indicated with the virtual input image data input from the switch 110c-2 as an allocating part designated with the second allocating control signal input from the mode controller 112, and outputs the screen data indicating the allocating part to the display unit 132-2 while keeping the specified direction of the allocating part in accordance with the second allocating control signal as the vertically long direction. As a result, the display regions of the displays 132-1 and 132-2 as the screen regions display the image of channel 1 and the virtual input image, respectively, in the vertically long direction.

When the mode controller 112 determines the display mode as hybrid display in landscape view, the contact position converter 114 determines the contact position detected by the touch sensor 134-1 as the contact position in the screen region of channel 1. The contact position converter 114 therefore does not convert the coordinates of the contact position indicated with the contact position data input from the touch sensor 134-1, and outputs them as contact position data corresponding to channel 1 to the system device 120. The virtual input controller 116 creates an operation signal in accordance with the contact position data input from the touch sensor 134-2 as stated above, and outputs the created operation signal to the system device 120.

The virtual input controller 116 may vary the virtual input region depending on the orientation of the information processing apparatus 10. In one example, when the mode controller 112 determines the display mode as hybrid display in portrait view, the mode controller 112 controls to display an image in horizontally-long direction of channel 1 in the display region of the display 132-1, and the virtual input controller 116 sets a horizontally-long virtual input region on the display region of the display 132-1 (FIG. 4). In this case, when the mode controller 112 determines the display mode as hybrid display in landscape view, the virtual input controller 116 sets virtual input image data that is set in the horizontally-long direction beforehand active and outputs this data to the switch 110c-2.

The mode controller 112 refers to the setting information on the virtual input region relating to the active virtual input image data, and determines the entire virtual input image as an allocating part to the display 132-2. Then the mode controller 112 determines the horizontally-long direction as the allocation direction of the determined allocating part. The mode controller 112 specifies the origin of the display 132-2 as the starting point of the allocation destination. The mode controller 112 creates an allocation control signal indicating the position of the starting point, the size and the allocation direction at the allocation destination of the determined allocating part to the display 132-2, and outputs the created allocation control signal to the switch 110d-2. As a result, the display regions of the displays 132-1 and 132-2 as the screen regions display the image of channel 1 and the virtual input image, respectively, in the horizontally long direction.

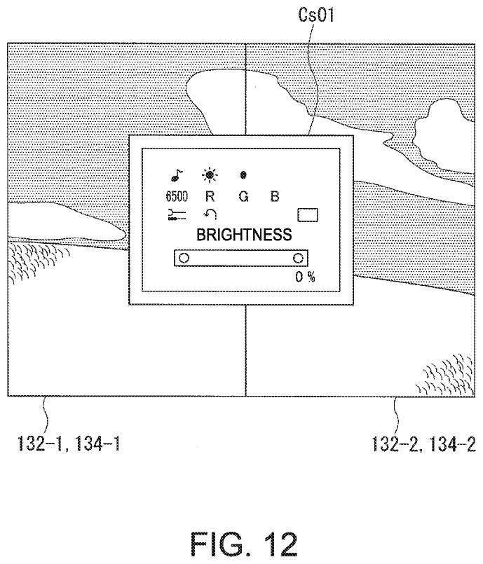

FIG. 11 shows the example of allocating one of the display regions of the displays 132-1 and 132-2 and the other display region to an image of channel 1 and the virtual input image, respectively, and the subject disclosure is not limited to such an example. The display region of the image of channel 1 may be the full display region, and the virtual input region, which is a display region of the virtual input image, may be a part of the full display region. The virtual input region may extend across a part of the display region of the display 132-1 and a part of the display region of the display 132-2. FIG. 12 shows an example where the full display region displays an image of channel 1 in the horizontally long direction, and a virtual input region is set at a center part of the full display region. The horizontal and vertical lengths of the virtual input region are shorter than half the horizontal and vertical lengths of the full display region, respectively. The virtual input region displays a device setting screen Cs that is one example of the virtual input image. The device setting screen includes a button indicating a device having a parameter to be set, and a slider bar to set the brightness (luminance). The brightness is about an image to be displayed on the displays 132-1 and 132-2.

Assume the case where the mode controller 112 determines a display mode as single display in landscape view and controls to display an image of channel 1 on the full display region in the horizontally-long direction. In this case, when the operation signal indicating the pressing of a predetermined device setting button is input, then the mode controller 112 determines the display mode as hybrid display. In response to the inputting of the operation signal, the virtual input controller 116 outputs virtual input image data indicating a device setting screen as the virtual input image to the switch 110c-2. The mode controller 112 then outputs, to the switch 110c-2, an output control signal designating the output of the virtual input image data from the virtual input controller 116 to the switches 110d-1 and 110d-2.

When the mode controller 112 determines the display mode as hybrid display in portrait view, the mode controller 112 creates a first image request signal indicating the resolution “1920×1080” and the orientation “landscape”, and outputs the created first image request signal to the I/F bridge 110b-1. The mode controller 112 creates a first output control signal designating the output of screen data from the I/F bridge 110b-1 to the switch 110d-1, and outputs the created first output control signal to the switch 110c-1.

The mode controller 112 determines, as an allocating part to the display 132-1, the entire image of the screen data of channel 1 that is input from the switch 110c-1 and determines the horizontally long direction as the allocation direction of the determined allocating part. The mode controller 112 creates a first allocation control signal indicating the origin as the position of the starting point, the size and the allocation direction at the allocation destination of the determined allocating part to the display 132-1, and outputs the created first allocation control signal to the switch 110d-1. The virtual input controller 116 outputs the virtual input image data that is set beforehand in the horizontally-long direction mode to the switch 110c-2.

The mode controller 112 then refers to the setting information on the virtual input region that is preset at the virtual input controller 116, and determines, as an allocating part to the displays 132-1 and 132-2, a part of the virtual input region that is overlapped with the display regions of the displays 132-1 and 132-2, and determines the vertically long direction as the allocation direction of the determined allocating part. The mode controller 112 creates a first allocation control signal and a second allocation control signal indicating the position of the starting point, the size and the allocation direction at the allocation destination of the allocating part in the displays 132-1 and 132-2, respectively. The mode controller 112 outputs the created first allocation control signal to the switch 110d-1, and outputs the created second allocation control signal to the switch 110d-2.

At this time, the contact position converter 114 converts the coordinates of a contact position detected by the touch sensor 134-1 and the coordinates of a contact position detected by the touch sensor 134-2 to the coordinates of the contact positions in the full detection region. The contact position converter 114 refers to the preset setting information on the virtual input region, and determines whether or not the converted contact position is included in the virtual input region. When it is determined that the converted contact position is included in the virtual input region, the contact position converter 114 outputs the contact position data indicating the converted contact position to the system device 120. When it is determined that the converted contact position is not included in the virtual input region, the contact position converter 114 creates an operation signal based on the contact position data indicating the converted contact position, and outputs the created operation signal to the system device 120.

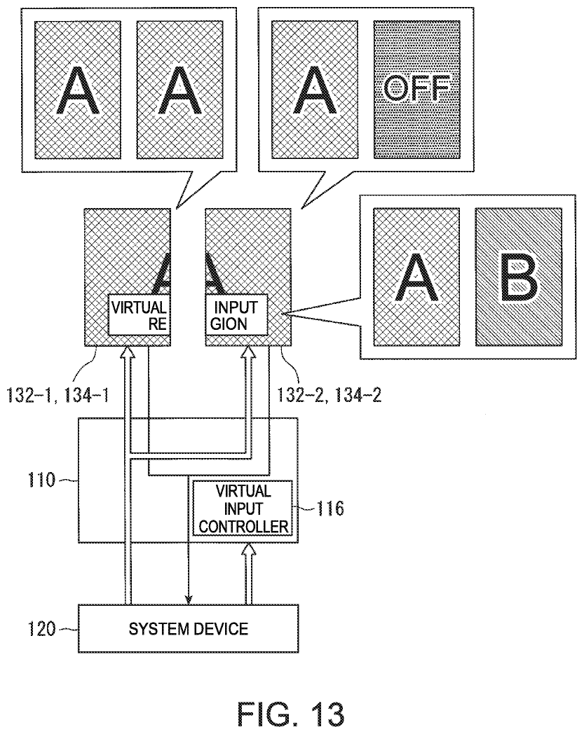

The mode controller 112 may change the display mode to the hybrid display from a display mode other than the single display in response to the inputting operation. Specifically the mode controller 112 may perform such a change of the display mode from dual display, which may be either the landscape view or the landscape view. In this case, the image of channel 1 may be displayed on either the display region of the display 132-1 or the display 132-2 (FIG. 13). Changing of the display mode from single display or dual display to hybrid display by the mode controller 112 corresponds to the control so that the virtual input controller 116 displays a virtual input image and so the virtual input control starts. When the mode controller 112 changes the display mode from hybrid display to single display or dual display, the mode controller 112 controls the virtual input controller 116 to stop the displaying of the virtual input image, and stops the output of an operation signal, which is created based on the contact position data indicating the contact position in the virtual input region displaying the virtual input image, to the system device 120 (virtual input control).

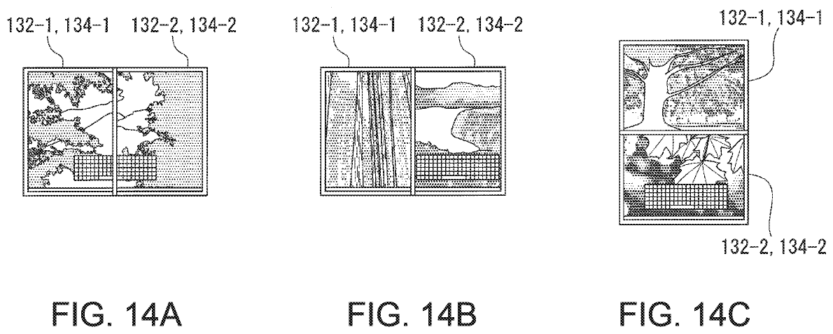

FIG. 14A shows an example of the display mode of hybrid display that is changed from single display. This example shows the case of placing the full display region in the horizontally-long direction. An image of one frame is displayed in the horizontally-long direction on the full display region, and a virtual input region is displayed on a part of the full display region so as to extend across the display regions of the displays 132-1 and 132-2. The virtual input region displays an image of the keyboard.

FIG. 14B shows an example of the display mode of hybrid display that is changed from dual display. This example shows the case of placing the full display region in the horizontally-long direction, and mutually different images of two frames are displayed in the vertically long direction on the display regions of the displays 132-1 and 132-2. The virtual input region is included in the display region of the display 132-2, and is not included in the display region of the display 132-1.

FIG. 14C shows another example of the display mode of hybrid display that is changed from dual display. This example shows the case of placing the full display region in the vertically-long direction, and mutually different images of two frames are displayed in the horizontally long direction on the display regions of the displays 132-1 and 132-2. The virtual input region is included in the display region of the display 132-2, and is not included in the display region of the display 132-1.

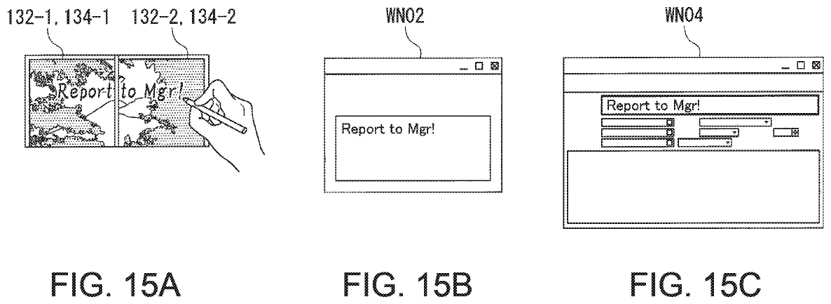

The input/output hub 110 may further include a trajectory input processor 118 (not shown). The trajectory input processor 118 acquires a continuous curve that is a trajectory of the contact positions in the entire detection region across the detection regions of the touch sensors 134-1 and 134-2 superimposed on the screen regions of the channels. In the example shown in FIG. 15A, the continuous curve shows handwritten characters “Report to Mgr!”. To identify the end of a section to acquire the continuous curve at one time, the trajectory input processor 118 detects the continuity of predetermined stop duration (e.g., 0.1 to 0.3 sec.) or longer of not detecting the detection position after the final stopping of the input of the detection position data. The trajectory input processor 118 may display an input window in a predetermined input information display region that is a part of the display regions of the displays 132-1 and 132-2, and display the acquired curve on a predetermined input information display field included in the displayed input window.

In the example shown in FIG. 15B, the input handwritten characters “Report to Mgr!” are shown in the input information display field in the input window WN02. The trajectory input processor 118 may detect a pattern (hereinafter, operation pattern) of a predetermined operation from the operation signal, and may perform the control, such as acquisition start, stop and save of the curve in accordance with the detected operation pattern. In one example, when a first operation pattern is detected, the trajectory input processor 118 starts to acquire the curve. When a second operation pattern is detected, the trajectory input processor 118 may output input information containing the acquired curve to the system device 120, and then stops the display of the input window. Examples of the first operation pattern include a drag operation and a swipe operation that are the operation for a predetermined pattern defining the trajectory. Examples of the second operation pattern include a click operation, a double-click operation, and a tap operation that are the operation for a predetermined pattern without the movement of a designated position. The trajectory input processor 118 may add position information indicating the position of a representative point of each continuous curve to the input information. For the representative point, the trajectory input processor 118 may use any one of the starting point, the end point, the center of gravity, and the midpoint, for example.

The trajectory input processor 118 may perform known character recognition processing to the acquired curve to acquire the recognized character string. While the system device 120 is waiting for the input of a character string during the executed processing, the trajectory input processor 118 outputs text information indicating the acquired series of character strings to the system device 120. The system device 120 uses the character string indicated by the text information input from the virtual input controller 116 for the currently executing processing. In the example shown in FIG. 15C, “Report to Mgr!” is input as the character string recognized from the handwritten characters, and the input character string is displayed in an active input field of the window WN04 displayed by the system device 120. The system device 120 indicates the active input field, and shows that the system device 120 is waiting for character information via the input field. In one example, the system device 120 executes an application program, and selects an input field that is included in the position designated by an operation signal input to the system device 120 among a plurality of input fields of the window WN04 as an active input field. This implements a desired text input based on the character string recognized from the handwritten characters that the user input through the operation.

When the posture mode is laptop mode, book mode or tablet mode, the mode controller 112 may select line feed display as the display mode in accordance with the inputting of a predetermined operation signal. The line feed display is a display mode of dividing an elongated image having the length of one side that is longer than the other side in the longitudinal direction to form allocating parts, and then allocating these allocating parts to a plurality of display regions that are arranged in the direction orthogonal to the longitudinal direction without changing the direction of the allocating parts, and sequentially displaying these allocated parts (by line feeding). This line feed display is grouped into landscape view and portrait view. The mode controller 112 may select any one of the landscape view and the portrait view based on the orientation of the information processing apparatus 10 as stated above. The line feed display can be dealt with as one form of the single display.

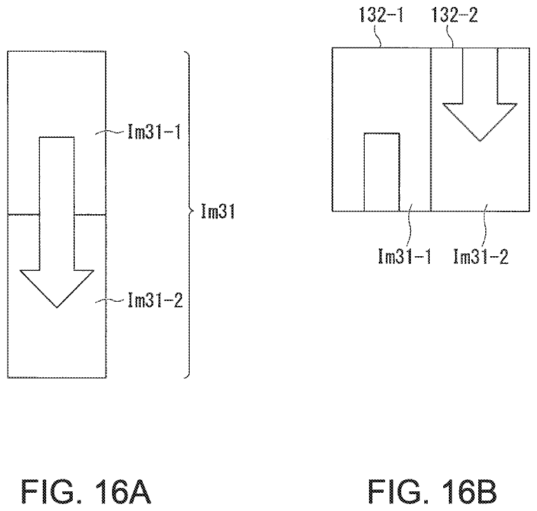

FIGS. 16A-16B explain examples of the line feed display in landscape view as a display mode. FIG. 16A shows an image Im31 made up of vertically long partial images Im31-1 and the Im31-2 that are connected in the vertical direction. The mode controller 112 acquires screen data indicating the image Im31 from the system device 120, and controls so that the display region of the display 132-1 displays the partial image Im31-1 of the image Im31 in the vertically-long direction and the display region of the display 132-2 adjacent to the display 132-1 on the laterally right displays the partial image Im31-2 in the vertically long direction.

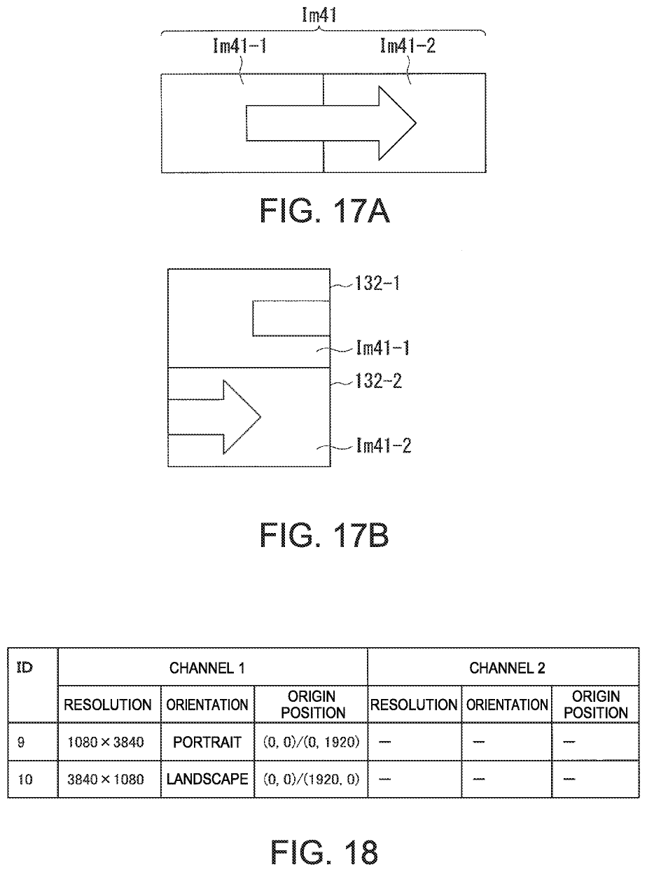

FIGS. 17A-17B explain examples of the line feed display in portrait view as a display mode. FIG. 17A shows an image Im41 made up of horizontally long partial images Im41-1 and the Im41-2 that are connected in the horizontal direction. The mode controller 112 acquires screen data indicating the image Im41 from the system device 120, and controls so that the display region of the display 132-1 displays the partial image Im41-1 of the image Im41 in the horizontally-long direction and the display region of the display 132-2 downward adjacent to the display 132-1 displays the partial image Im41-2 in the horizontally long direction.

A control table shown as an example in FIG. 18 contains the setting information of display modes corresponding to ID9 and ID10. The control table in this drawing omits the setting information of ID1 to ID8 (FIG. 6). ID9 shows a display mode that is line feed display in landscape view. The setting information of the display mode with ID9 shows “1080×3840” as the resolution, “portrait” as the orientation, and “(0,0)/(0, 1920)” as the origin position of an image of channel 1, and does not include information on an image of channel 2. This information indicates that each of the parts making up the image of channel 1 are allocated in the vertically long direction in the full display region with the origin as the starting point. When the mode controller 112 determines the display mode as single display in the horizontally long direction, the mode controller 112 refers to the setting information corresponding to ID9, creates an image request signal indicating the resolution “1080×3840” and the orientation “portrait”, and outputs the created image request signal to the I/F bridge 110b-1. The mode controller 112 creates an output control signal designating the output of screen data from the I/F bridge 110b-1 to the switches 110d-1 and 110d-2, and outputs the created output control signal to the switch 110c-1.

The mode controller 112 then refers to the preset setting information on the display region of the display 132-1, and determines, as an allocating part to the display 132-1, a part of the size “1080×1920” starting from the origin in the image of the screen data input from the switch 110c-1 and determines the vertically long direction as the allocation direction of the determined allocating part. The mode controller 112 specifies the origin of the display region of the display 132-1 as the origin of the allocation destination corresponding to the origin (0,0). The mode controller 112 creates an allocation control signal indicating the position of the starting point, the size and the allocation direction at the allocation destination of the determined allocating part to the display 132-1, and outputs the created allocation control signal to the switch 110d-1.

The mode controller 112 determines, as an allocating part to the display 132-2, a part of the size “1080×1920” starting from the coordinates (0,1920) that is the remaining part in the image of the screen data input from the switch 110c-1 and determines the horizontally long direction as the allocation direction of the determined allocating part. The mode controller 112 specifies the origin of the display region of the display 132-2 corresponding to the coordinates (0, 1920) as the origin of the allocation destination. The mode controller 112 creates an allocation control signal indicating the position of the starting point, the size and the allocation direction at the allocation destination of the determined allocating part to the display 132-2, and outputs the created allocation control signal to the switch 110d-2.

The contact position converter 114 refers to the setting information corresponding to ID9 selected by the mode controller 112, and converts the coordinates of contact positions detected by the touch sensors 134-1 and 134-2 to the coordinates in the vertically-long screen region of channel 1 having the size of “1080×3840”. The contact position converter 114 directly sets a contact position in the vertically-long contact region indicated by the contact position data that is input from the touch sensor 134-1 as a contact position of channel 1. The contact position converter 114 adds the coordinates (0, 1920) in the screen region of channel 1 corresponding to the origin of the detection region of the touch sensor 134-2 to the coordinates of a contact position in the vertically-long contact region indicated by the contact position data that is input from the touch sensor 134-2, and sets the calculated coordinates. The contact position converter 114 then outputs the contact position data indicating the coordinates of the determined contact positions to the system device 120.

ID10 shows a display mode that is line feed display in portrait view. The setting information of the display mode with ID10 shows “3840×1080” as the resolution, “landscape” as the orientation, and “(0,0)/(1920,0)” as the origin position of an image of channel 1, and does not include information on an image of channel 2. This information indicates that each of the parts making up the image of channel 1 are allocated in the horizontally long direction in the full display region with the origin as the starting point. When the mode controller 112 determines the display mode as single display in the vertically long direction, the mode controller 112 refers to the setting information corresponding to ID10, creates an image request signal indicating the resolution “3840×1080” and the orientation “landscape”, and outputs the created image request signal to the I/F bridge 110b-1. The mode controller 112 creates an output control signal indicating the output of screen data from the I/F bridge 110b-1 to the switches 110d-1 and 110d-2, and outputs the created output control signal to the switch 110c-1.

The mode controller 112 then refers to the preset setting information on the display region of the display 132-1, and determines, as an allocating part to the display 132-1, a part of the size “1920×1080” starting from the origin in the image of the screen data input from the switch 110c-1 and determines the vertically long direction as the allocation direction of the determined allocating part. The mode controller 112 specifies the origin of the display region of the display 132-1 as the origin of the allocation destination corresponding to the origin (0,0). The mode controller 112 creates an allocation control signal indicating the position of the starting point, the size and the allocation direction at the allocation destination of the determined allocating part in the display 132-1, and outputs the created allocation control signal to the switch 110d-1.

The mode controller 112 determines, as an allocating part to the display 132-2, a part of the size “1920×1080” starting from the coordinates (1920,1080) that is the remaining part in the image of the screen data input from the switch 110c-1 and determines the horizontally long direction as the allocation direction of the determined allocating part. The mode controller 112 specifies the origin of the display region of the display 132-2 corresponding to the coordinates (1920, 0) as the origin of the allocation destination. The mode controller 112 creates an allocation control signal indicating the position of the starting point, the size and the allocation direction at the allocation destination of the determined allocating part to the display 132-2, and outputs the created allocation control signal to the switch 110d-2.

The above mainly describes the case where the information processing apparatus 10 is a laptop PC having two chassis and having a variable angle θ around the rotating shaft of the hinge mechanism 121. The subject disclosure is not limited to such a configuration. The information processing apparatus 10 is not limited to the laptop PC, which may be in another form, such as a mobile phone. The number of the display regions of the information processing apparatus 10 that are controllable independently for the image display is not limited to 2, and may be 3 or more. The number of the display regions and the number of the detection regions of the information processing apparatus 10 may be different. A detection region may be superimposed on each of at least two display regions that are spatially adjacent to each other. The mode controller 112 controls the display mode about two or more display regions and the detection regions each being superimposed on the corresponding display region.

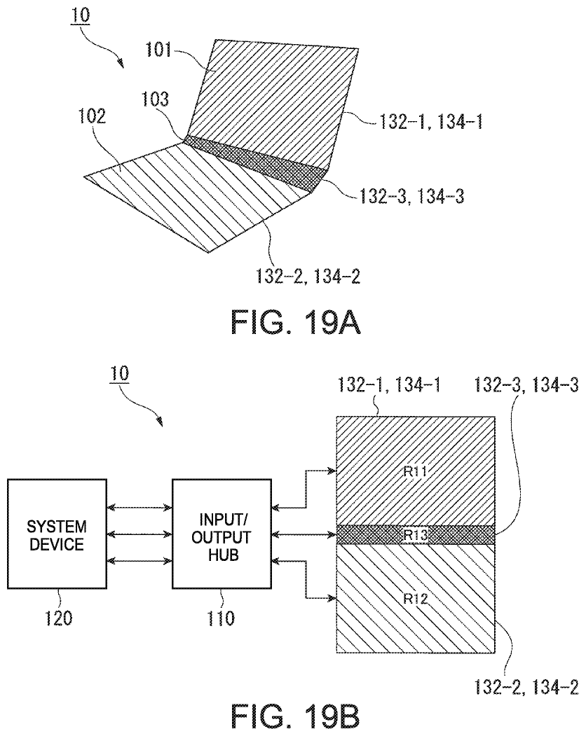

In examples shown in FIGS. 19A-19B, the information processing apparatus 10 includes three chassis that are a first chassis 101 to a third chassis 103. One side of the first chassis 101 engages with one side of the second chassis 102, and a first angle θ between the surface of the first chassis 101 and the surface of the second chassis 102 is variable. One side of the third chassis 103 engages with another side of the second chassis 102, and a second angle θ between the surface of the third chassis 103 and the surface of the second chassis 102 also is variable. The first chassis 101 to the third chassis 103 are equal in the width in the horizontal direction. While the surfaces of the first chassis 101 and the third chassis 103 are equal in the length in the vertical direction, the surface of the second chassis 102 has a very short length in the vertical direction. With such a configuration, when both of the first angle θ and the second angle θ are 180°, the surfaces of the first chassis 101 to the third chassis 103 define a continuous flat face. When both of the first angle θ and the second angle θ are 90°, the surface of the first chassis 101 is opposed to the surface of the third chassis 103, so that the device has an appearance like a binder file. The first chassis 101, the second chassis 102 and the third chassis 103 have the surfaces having the displays 132-1, 132-2, and 132-3, respectively, each having a display region. Detection regions of the touch sensors 134-1, 134-2, and 134-3 are superimposed on the display regions of the displays 132-1, 132-2, and 132-3, respectively.

The mode controller 112 of the input/output hub 110 controls the display mode in accordance with any one of an input operational signal, the first angle, the second angle, and the orientation of the information processing apparatus 10, or a combination of them. The mode controller 112 determines one or more screen regions for the display mode, and each of the screen regions may include one display region or two or more display regions that are spatially adjacent to each other. For example, each of the screen regions may be a display region (region R11) of the display 132-1, a display region (region R12) of the display 132-2, a display region (region R13) of the display 132-3, a combination of the region R11 and the region R12 (combination 1), a combination of the region R12 and the region R13 (combination 2), or a combination of the region R11, the region R12 and the region R13 (full display region), The mode controller 112 may determine one or more screen regions so as not to have a mutually overlapping region and so as not to exceed the full display region. That is, one or more screen regions for the display modes that the mode controller 112 can select has ten patterns in total, including the region R11, the region R12, the region R13, the region R11 and the region R12 (two regions), the region R12 and the region R13 (two regions), the region R11 and the region R13 (two regions), the region R11, the region R12 and the region R13 (three regions), the combination 1 and the region R13 (two regions), the combination 2 and the region R11 (two regions), and the full display region. The mode controller 112 may select landscape view or portrait view depending on the orientation of the information processing apparatus 10, e.g., of the region R12.

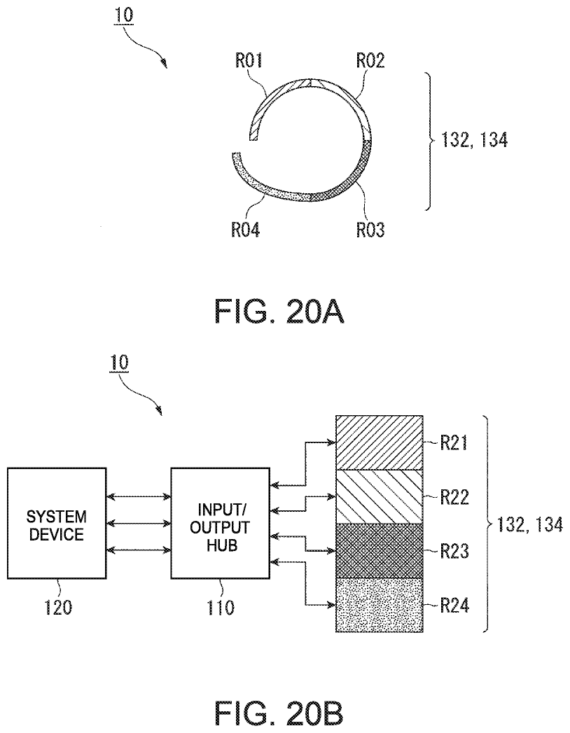

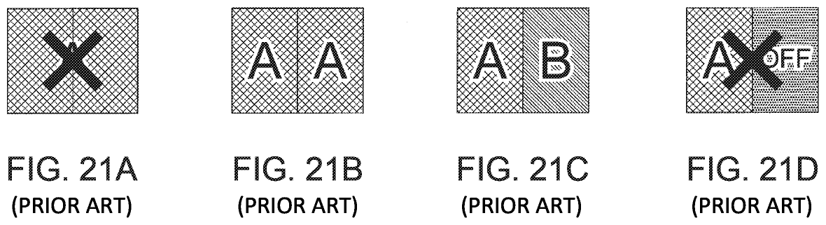

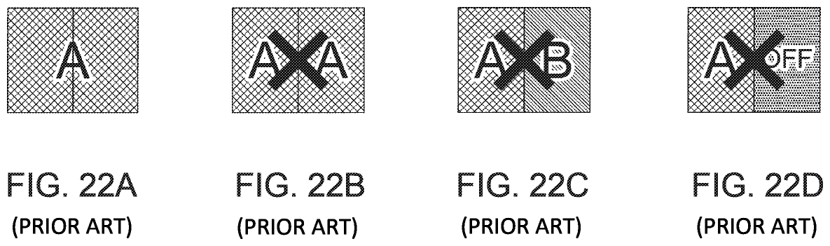

The number of the display 132 and the number of the touch sensor 134 of the information processing apparatus 10 may be one, as long as the number of the display regions that are independently controllable by the mode controller 112 for the output of various types of screen data and the number of the detection regions that are controllable by the mode controller 112 for the input of contact position data are plural. In the example of FIGS. 20A-20B, the display 132 is configured as a flexible display having the touch sensor 134 superimposed on the display. The flexible display has a substrate made of a flexible dielectric material that is bendable with the user's operation. The substrate may include synthetic resin, such as polyimide, as the raw material. The entire display region of the display 132 is divided into four display regions R21 to R24. The entire detection region of one touch sensor 134 is divided into four detection regions, and each of these detection regions is superimposed on the corresponding display region R21 to R24.

The mode controller 112 of the input/output hub 110 controls the display mode in accordance with an input operational signal. Each of the screen regions making up the display mode includes one display region or two or more display regions that are spatially adjacent to each other. For example, these screen regions include the display region R21, the display region R22, the display region R23, the display region R24, a combination of the display region R21 and the display region R22 (combination 12), a combination of the display region R22 and the display region R23 (combination 23), a combination of the display region R23 and the display region R24 (combination 34), a combination of the display regions R21, R22 and R23 (combination 123), a combination of the display regions R22, R23 and R24 (combination 234), and a combination of the display regions R21, R22, R23 and R24 (full display region). The mode controller 112 may determine one or more screen regions so as not to have a mutually overlapping region and so as not to exceed the full display region for each of the display modes. The mode controller 112 may select landscape view or portrait view in accordance with the input operation signal and depending on the orientation of the information processing apparatus 10.

In the above example, some of the elements may be omitted. In one example, the information processing apparatus 10 may not have a touch sensor 134. The input/output hub 110 may not have one of or both of the contact position converter 114 and the virtual input controller 116. The mode controller 112 may not detect the orientation of the information processing apparatus 10, and may not change the landscape view and the portrait view as the display mode and fix the display mode at one of them. The mode controller 112 may omit the determination of some posture modes, such as laptop mode, and may determine it as book mode. The angle θ of the information processing apparatus 10 is variable between 0 and 180°, and may not be changed to exceed 180°.

As described above, the information processing apparatus 10 of the subject disclosure includes: an input/output controller (e.g., input/output hub 110); display units (e.g., displays 132-1 and 132-2) that are independently controllable for image display; and the system device 120 that operates in accordance with the OS and is configured to acquire screen data of at least one channel. The input/output controller determines a screen region for each channel in at least two display regions of the display units, and outputs request information (e.g., an image request signal) for screen data corresponding to the screen region to the system device 120.

The screen region corresponding to the channel may include regions extending across at least two display regions. With this configuration, the input/output controller determines a screen region that is a part or the entire of the plurality of display regions for each channel, requests screen data for the screen region, and displays an image that the requested screen data indicates on the screen region of the corresponding channel. This enables flexible control of the screen region to display screen data extending across the plurality of display regions without dependence on the OS.

For the information processing apparatus 10, the request information may contain the size of the screen region for each channel and the orientation to display the screen data. With this configuration, the system device acquires screen data indicating an image having the size and the orientation of the determined screen region, and displays the image on the screen region of the corresponding channel.

The information processing apparatus 10 may include chassis (e.g., the first chassis 101 and the second chassis 102) having at least two display regions and detectors (e.g., the acceleration sensors 144a and 144b) configured to detect the physical amount in accordance with the posture of the chassis. The input/output controller may determine a display mode to show a screen region for each channel depending on the posture of the chassis.

This configuration enables the display of a display region of the channel corresponding to the screen region determined depending on the arrangement of the display region that may change with the posture of the chassis. The user therefore is allowed to view an image arranged depending on the posture of the chassis without performing any special operation.

The input/output controller of the information processing apparatus 10 also may determine the orientation of the chassis and refer to the detected orientation to determine the display mode (e.g., landscape view and portrait view). This configuration enables the orientation of a screen region depending on the orientation of the display region as a whole of the chassis. The user therefore is allowed to view an image arranged depending on the orientation of the chassis without performing any special operation.

The information processing apparatus 10 may include a detector (e.g., the touch sensors 134-1 and 134-2) having a detection region that is superimposed on each of the at least two display regions, the detection region being to detect a contact with an object. When the determined screen region extends across at least two display regions, the input/output controller converts the coordinates of a contact position where a contact is detected in the detection region superimposed on each of the at least two display regions to the coordinates in the screen region, and outputs the contact position data indicating the converted coordinates to the system device 120.

In the case where the contact position in the detection regions corresponding to the plurality of display regions extends across the detection regions as well, the coordinates that are unified in the screen region can be given to the system device 120, and the coordinate system of the detected position data extending across a plurality of detection regions is flexibly controllable without dependence on the OS. When the input/output controller in the information processing apparatus 10 selects a display mode (e.g., hybrid display) including a virtual input region that is at least a part of the detection region corresponding to each of the two or more display regions, the input/output controller may control to display an image of a predetermined input unit in the virtual input region. When a contact is detected in the region displaying a component (e.g., a key of the keyboard) of the input unit, the input/output controller may output an operation signal indicating the operation of the component to the system device 120.

This configuration does not have an actual input unit, and receives an input to the input unit displayed as an image without dependence on the OS to implement an operation based on the received input. The input/output controller in the information processing apparatus 10 may acquire input information based on the trajectory of contact positions having converted coordinates in the screen region, and output the acquired input information to the system device 120. This configuration acquires the trajectory of contact positions represented with the coordinates that are unified in the screen region extending across a plurality of detection regions. The system device 120 therefore acquires the trajectory acquired without dependence on the OS as flexible drawing information, and implements the processing based on the acquired drawing information (e.g., saving the memo).

The input/output controller in the information processing apparatus 10 may recognize one or more characters indicated by the trajectory of contact positions, and output text information indicating the recognized characters to the system device 120. This configuration does not have a dedicated character-input device, such as a keyboard, and the configuration still allows the system device 120 to acquire text information indicating characters based on the trajectory acquired without dependence on the OS. The system device 120 therefore effectively implements the processing based on the acquired text information (e.g., inputting the characters).

The specific configuration of the subject disclosure is not limited to the above-described examples, and also includes design modifications or the like within the scope of the subject disclosure. The configurations described in the above examples can be combined as needed unless such a combination is inconsistent with subject disclosure. Examples may be practiced in other specific forms. The described examples are to be considered in all respects only as illustrative and not restrictive. The scope of the technology is, therefore, indicated by the appended claims rather than by the foregoing description. All changes which come within the meaning and range of equivalency of the claims are to be embraced within their scope.

What is claimed is:

1. An apparatus comprising:
a display unit having at least two display regions that are independently controllable for image display, wherein each of the at least two display regions comprises a channel;
a system device configured to execute an operating system (OS) and to acquire screen data of at least one channel; and
an input/output controller configured to determine a screen region for each channel in the at least two display regions, and to output request information for screen data corresponding to the screen region to the system device.

2. The apparatus of claim 1, wherein the screen region corresponding to the channel includes a region extending across the at least two display regions.

3. The apparatus of claim 1, wherein the request information comprises information on a size of the screen region and an orientation to display the screen data.

4. The apparatus of claim 1, further comprising:
a chassis supporting the at least two display regions; and
a detector configured to detect a physical amount in accordance with posture of the chassis, wherein the input/output controller determines a display mode to show a screen region for the channel in accordance with the posture.

5. The apparatus of claim 4, wherein the input/output controller detects a direction of one display region of the at least two display regions relative to a user, and refers to the direction to determine the display mode.

6. The apparatus of claim 1, further comprising:
a detector having a detection region that is superimposed on each of the at least two display regions, the detection region configured to detect a contact with an object; and
wherein when the screen region extends across the at least two display regions, the input/output controller converts coordinates of a contact position where a contact is detected in the detection region superimposed on each of the at least two display regions to coordinates in the screen region, and outputs contact position data indicating the converted coordinates to the system device.

7. The apparatus of claim 6, wherein when selecting a display mode including a virtual input region that is at least a part of the detection region, the input/output controller controls to display an image of a predetermined input unit in the virtual input region, and when a contact is detected in a region displaying a component of the predetermined input unit, the input/output controller outputs an operating signal indicating an operation of the component to the system device.

8. The apparatus of claim 6, wherein the input/output controller acquires input information based on a trajectory of the contact position with converted coordinates, and outputs the input information to the system device.

9. The apparatus of claim 8, wherein the input/output controller recognizes one or more characters that the trajectory indicates, and outputs text information indicating the characters to the system device.

10. A method for controlling display output of an apparatus with at least two display regions, the method comprising:
determining a screen region corresponding to a channel in the at least two display regions; and
outputting request information for screen data corresponding to the screen region to a system device.

11. The method of claim 10, further comprising:
detecting a physical amount in accordance with a posture of a chassis; and
determining a display mode to show a screen region for the channel in accordance with the posture.

12. The method of claim 11, further comprising:
detecting a direction of one display region of the at least two display regions relative to a user; and
determining, in response to the direction, the display mode.

13. The method of claim 10, further comprising:
superimposing, a detection region on each of the at least two display regions, wherein the detection region is configured to detect a contact with an object;
converting, in response to determining that the screen region extends across the at least two display regions, coordinates of a contact position where a contact is detected in the detection region that is superimposed on each of the at least two display regions to coordinates in the screen region; and
outputting contact position data indicating the converted coordinates to a system device.

14. The method of claim 13, further comprising:
displaying, in response to selecting a display mode that includes a virtual input region that is at least part of the detection region, an image of a predetermined input unit in the virtual input region; and
outputting, in response to detecting a contact in a region displaying a component of the predetermined input unit, an operating signal indicating an operation of a component to the system device.

15. The method of claim 13, further comprising:
acquiring input information based on a trajectory of the contact position with converted coordinates; and
outputting the input information to the system device.

16. The method of claim 15, further comprising:
recognizing one or more characters that the trajectory indicates; and
outputting text information indicating the characters to the system device.

17. A computer-readable storage medium that stores a program executable by a processor, the executable program comprising instructions to cause the processor to perform steps comprising:
determining a screen region corresponding to a channel in at least two display regions; and
outputting request information for screen data corresponding to the screen region to a system device.

18. The computer-readable storage medium of claim 17, wherein the steps further comprise:
detecting a physical amount in accordance with a posture of a chassis; and
determining a display mode to show a screen region for the channel in accordance with the posture.

19. The computer-readable storage medium of claim 18, wherein the steps further comprise:
detecting a direction of one display region of the at least two display regions relative to a user; and
determining, in response to the direction, the display mode.

20. The computer-readable storage medium of claim 19, wherein the steps further comprise:
superimposing, a detection region on each of the at least two display regions, wherein the detection region is configured to detect a contact with an object;
converting, in response to determining that the screen region extends across the at least two display regions, coordinates of a contact position where a contact is detected in the detection region that is superimposed on each of the at least two display regions to coordinates in the screen region; and
outputting contact position data indicating the converted coordinates to a system device.
